(19) United States
(12) Patent Application Publication
(10) Pub. No.: US 2026/0080085 A1
(43) Pub. Date: Mar. 19, 2026

(54) DISABLING ACCESS TO SENSOR DATA

(71) Applicant: Apple Inc., Cupertino, CA (US)

(72) Inventors: D J CAPELIS, San Francisco, CA (US); Gabrielle A. BELZBERG, Los Gatos, CA (US)

(21) Appl. No.: 19/083,799

(22) Filed: Mar. 19, 2025

Related U.S. Application Data
(60) Provisional application No. 63/696,782, filed on Sep. 19, 2024.

(51) Int. Cl. G06F 21/62

(52) U.S. Cl. CPC G06F 21/6218

(57) ABSTRACT

The present disclosure generally relates to disabling access to sensor data. Some techniques are for disabling access to a sensor when a device is face down in accordance with some embodiments. Other techniques are for performing an operation requiring sensor access based on an orientation of a device and previous sensor data in accordance with some embodiments. Other techniques are for managing processes in a containerized multiprocessor system that is in communication with sensors in accordance with some embodiments.

### CROSS-REFERENCE TO RELATED APPLICATIONS

The present application claims priority to U.S. Provisional Patent Application Ser. No. 63/696,782, entitled “DISABLING ACCESS TO SENSOR DATA” filed Sep. 19, 2024, which is hereby incorporated by reference in its entirety for all purposes.

### BACKGROUND

Electronic devices often include sensors that are configured to provide sensor data to different applications. Traditional approaches for managing access to sensor data access may not adequately address complex scenarios where electronic devices need to balance user privacy with functionality. Accordingly, there is a need for more robust systems for managing access to sensor data on electronic devices.

### SUMMARY

Current techniques for disabling access to sensor data are generally ineffective and/or inefficient. For example, some techniques rely on simple software switches that can be bypassed by malicious applications, potentially compromising user privacy. This disclosure provides more effective and/or efficient techniques for disabling access to sensor data using examples of a compartmentalized architecture with memory management, processor separation, and/or software isolation. It should be recognized that other types of software and/or hardware architectures can be used with techniques described herein. For example, a distributed system across multiple different electronic devices can implement techniques described herein. In addition, techniques optionally complement or replace other techniques for disabling access to sensor data.

Some techniques are described herein for selectively allowing sensor data access based on device orientation. For example, when a device is in a first orientation (e.g., face up), an application is enabled to receive sensor data from a sensor. Conversely, when the device is in a second orientation (e.g., face down), the application is disabled from receiving sensor data from the sensor. Such techniques can further be based on previous sensor data. For example, the device selectively allows sensor data access based on specific combinations of orientation (e.g., face up or face down) and previous sensor data (e.g., high velocity and/or sudden movement) that enables context-aware sensor data access determinations that can prioritize emergency functions while maintaining privacy in normal circumstances. Other techniques described herein involve a compartmentalized multiprocessor architecture for managing sensor data flow. For example, a Secure Page Table Monitor (SPTM) manages memory across a device with a first processor (e.g., an Always-On Processor) and a second processor (e.g., an Application Processor). The SPTM oversees different kernels creating trusted and untrusted containers on each processor, with the trusted container on the first processor communicating with input and/or output (I/O) devices.

In some embodiments, a method that is performed at a device, by a system process of the device, that is in communication with a first sensor is described. In some embodiments, the method comprises: receiving, from an application of the device, a request for sensor data from the first sensor; in response to receiving the request for sensor data from the first sensor, sending, to a first process different from the system process, a request for an orientation of a portion of the device; after sending the request for an orientation of the portion of the device, receiving, from the first process, an indication of a respective orientation of the portion of the device; and in response to receiving the indication of the respective orientation of the portion of the device: in accordance with a determination that the respective orientation is a first orientation, enabling, the application of the device, to receive sensor data from the first sensor; and in accordance with a determination that the respective orientation is a second orientation different from the first orientation, disabling, the application of the device, to receive sensor data from the first sensor.

In some embodiments, a non-transitory computer-readable storage medium storing one or more programs configured to be executed by one or more processors of a device, by a system process of the device, that is in communication with a first sensor is described. In some embodiments, the one or more programs includes instructions for: receiving, from an application of the device, a request for sensor data from the first sensor; in response to receiving the request for sensor data from the first sensor, sending, to a first process different from the system process, a request for an orientation of a portion of the device; after sending the request for an orientation of the portion of the device, receiving, from the first process, an indication of a respective orientation of the portion of the device; and in response to receiving the indication of the respective orientation of the portion of the device: in accordance with a determination that the respective orientation is a first orientation, enabling, the application of the device, to receive sensor data from the first sensor; and in accordance with a determination that the respective orientation is a second orientation different from the first orientation, disabling, the application of the device, to receive sensor data from the first sensor.

In some embodiments, a transitory computer-readable storage medium storing one or more programs configured to be executed by one or more processors of a device, by a system process of the device, that is in communication with a first sensor is described. In some embodiments, the one or more programs includes instructions for: receiving, from an application of the device, a request for sensor data from the first sensor; in response to receiving the request for sensor data from the first sensor, sending, to a first process different from the system process, a request for an orientation of a portion of the device; after sending the request for an orientation of the portion of the device, receiving, from the first process, an indication of a respective orientation of the portion of the device; and in response to receiving the indication of the respective orientation of the portion of the device: in accordance with a determination that the respective orientation is a first orientation, enabling, the application of the device, to receive sensor data from the first sensor; and in accordance with a determination that the respective orientation is a second orientation different from the first orientation, disabling, the application of the device, to receive sensor data from the first sensor.

In some embodiments, a device, by a system process of the device, configured to communicate with a first sensor is described. In some embodiments, the device comprises one or more processors and memory storing one or more programs configured to be executed by the one or more processors. In some embodiments, the one or more programs includes instructions for: receiving, from an application of the device, a request for sensor data from the first sensor; in response to receiving the request for sensor data from the first sensor, sending, to a first process different from the system process, a request for an orientation of a portion of the device; after sending the request for an orientation of the portion of the device, receiving, from the first process, an indication of a respective orientation of the portion of the device; and in response to receiving the indication of the respective orientation of the portion of the device: in accordance with a determination that the respective orientation is a first orientation, enabling, the application of the device, to receive sensor data from the first sensor; and in accordance with a determination that the respective orientation is a second orientation different from the first orientation, disabling, the application of the device, to receive sensor data from the first sensor.

In some embodiments, a device, by a system process of the device, configured to communicate with a first sensor is described. In some embodiments, the device comprises means for performing each of the following steps: receiving, from an application of the device, a request for sensor data from the first sensor; in response to receiving the request for sensor data from the first sensor, sending, to a first process different from the system process, a request for an orientation of a portion of the device; after sending the request for an orientation of the portion of the device, receiving, from the first process, an indication of a respective orientation of the portion of the device; and in response to receiving the indication of the respective orientation of the portion of the device: in accordance with a determination that the respective orientation is a first orientation, enabling, the application of the device, to receive sensor data from the first sensor; and in accordance with a determination that the respective orientation is a second orientation different from the first orientation, disabling, the application of the device, to receive sensor data from the first sensor.

In some embodiments, a computer program product is described. In some embodiments, the computer program product comprises one or more programs configured to be executed by one or more processors of a device, by a system process of the device, that is in communication with a first sensor. In some embodiments, the one or more programs include instructions for: receiving, from an application of the device, a request for sensor data from the first sensor; in response to receiving the request for sensor data from the first sensor, sending, to a first process different from the system process, a request for an orientation of a portion of the device; after sending the request for an orientation of the portion of the device, receiving, from the first process, an indication of a respective orientation of the portion of the device; and in response to receiving the indication of the respective orientation of the portion of the device: in accordance with a determination that the respective orientation is a first orientation, enabling, the application of the device, to receive sensor data from the first sensor; and in accordance with a determination that the respective orientation is a second orientation different from the first orientation, disabling, the application of the device, to receive sensor data from the first sensor.

In some embodiments, a method that is performed at a device, by a memory management process, that is in communication with one or more input devices, one or more output devices, or any combination thereof and that includes a first processor and a second processor is described. In some embodiments, the method comprises: creating, via a first kernel of the first processor, a trusted container and an untrusted container for the first processor, wherein the trusted container is separate from the untrusted container, wherein one or more processes of the trusted container are configured to communicate with the one or more input devices, the one or more output devices, or any combination thereof, and wherein one or more processes of the untrusted container are configured to not communicate with the one or more input devices, the one or more output devices, or any combination thereof; creating, via a second kernel of the second processor, a single container, wherein the second kernel is separate from the first kernel; and creating, via a third kernel of the second processor, multiple containers, wherein one or more processes of the single container are configured to communicate with the first processor via one or more processes of one or more containers of the multiple containers.

In some embodiments, a non-transitory computer-readable storage medium storing one or more programs configured to be executed by one or more processors of a device, by a memory management process, that is in communication with one or more input devices, one or more output devices, or any combination thereof and that includes a first processor and a second processor is described. In some embodiments, the one or more programs includes instructions for: creating, via a first kernel of the first processor, a trusted container and an untrusted container for the first processor, wherein the trusted container is separate from the untrusted container, wherein one or more processes of the trusted container are configured to communicate with the one or more input devices, the one or more output devices, or any combination thereof, and wherein one or more processes of the untrusted container are configured to not communicate with the one or more input devices, the one or more output devices, or any combination thereof; creating, via a second kernel of the second processor, a single container, wherein the second kernel is separate from the first kernel; and creating, via a third kernel of the second processor, multiple containers, wherein one or more processes of the single container are configured to communicate with the first processor via one or more processes of one or more containers of the multiple containers.

In some embodiments, a transitory computer-readable storage medium storing one or more programs configured to be executed by one or more processors of a device, by a memory management process, that is in communication with one or more input devices, one or more output devices, or any combination thereof and that includes a first processor and a second processor is described. In some embodiments, the one or more programs includes instructions for: creating, via a first kernel of the first processor, a trusted container and an untrusted container for the first processor, wherein the trusted container is separate from the untrusted container, wherein one or more processes of the trusted container are configured to communicate with the one or more input devices, the one or more output devices, or any combination thereof, and wherein one or more processes of the untrusted container are configured to not communicate with the one or more input devices, the one or more output devices, or any combination thereof; creating, via a second kernel of the second processor, a single container, wherein the second kernel is separate from the first kernel; and creating, via a third kernel of the second processor, multiple containers, wherein one or more processes of the single container are configured to communicate with the first processor via one or more processes of one or more containers of the multiple containers.

In some embodiments, a device, by a memory management process, configured to communicate with one or more input devices, one or more output devices, or any combination thereof and that includes a first processor and a second processor is described. In some embodiments, the device comprises one or more processors and memory storing one or more programs configured to be executed by the one or more processors. In some embodiments, the one or more programs includes instructions for: creating, via a first kernel of the first processor, a trusted container and an untrusted container for the first processor, wherein the trusted container is separate from the untrusted container, wherein one or more processes of the trusted container are configured to communicate with the one or more input devices, the one or more output devices, or any combination thereof, and wherein one or more processes of the untrusted container are configured to not communicate with the one or more input devices, the one or more output devices, or any combination thereof; creating, via a second kernel of the second processor, a single container, wherein the second kernel is separate from the first kernel; and creating, via a third kernel of the second processor, multiple containers, wherein one or more processes of the single container are configured to communicate with the first processor via one or more processes of one or more containers of the multiple containers.

In some embodiments, a device, by a memory management process, configured to communicate with one or more input devices, one or more output devices, or any combination thereof and that includes a first processor and a second processor is described. In some embodiments, the device comprises means for performing each of the following steps: creating, via a first kernel of the first processor, a trusted container and an untrusted container for the first processor, wherein the trusted container is separate from the untrusted container, wherein one or more processes of the trusted container are configured to communicate with the one or more input devices, the one or more output devices, or any combination thereof, and wherein one or more processes of the untrusted container are configured to not communicate with the one or more input devices, the one or more output devices, or any combination thereof; creating, via a second kernel of the second processor, a single container, wherein the second kernel is separate from the first kernel; and creating, via a third kernel of the second processor, multiple containers, wherein one or more processes of the single container are configured to communicate with the first processor via one or more processes of one or more containers of the multiple containers.

In some embodiments, a computer program product is described. In some embodiments, the computer program product comprises one or more programs configured to be executed by one or more processors of a device, by a memory management process, that is in communication with one or more input devices, one or more output devices, or any combination thereof and that includes a first processor and a second processor. In some embodiments, the one or more programs include instructions for: creating, via a first kernel of the first processor, a trusted container and an untrusted container for the first processor, wherein the trusted container is separate from the untrusted container, wherein one or more processes of the trusted container are configured to communicate with the one or more input devices, the one or more output devices, or any combination thereof, and wherein one or more processes of the untrusted container are configured to not communicate with the one or more input devices, the one or more output devices, or any combination thereof; creating, via a second kernel of the second processor, a single container, wherein the second kernel is separate from the first kernel; and creating, via a third kernel of the second processor, multiple containers, wherein one or more processes of the single container are configured to communicate with the first processor via one or more processes of one or more containers of the multiple containers.

In some embodiments, a method that is performed at a device that is communication with one or more sensors and one or more input devices is described. In some embodiments, the method comprises: receiving a request to perform an operation; and in response to receiving the request to perform the operation: in accordance with a determination that a first set of one or more criteria are satisfied, wherein the first set of one or more criteria includes a first criterion that is satisfied when the device is in a first orientation, wherein the first set of one or more criteria include a second criterion that is satisfied when sensor data of the one or more sensors that is detected before receiving the request to perform the operation satisfies a second set of one or more criteria different from the first set of one or more criteria, performing the operation; in accordance with a determination that a third set of one or more criteria, different from the first set of one or more criteria and the second set of one or more criteria, are satisfied, wherein the third set of one or more criteria include the first criterion that is satisfied when the device is in the first orientation, wherein the third set of one or more criteria include a third criterion that is satisfied when the sensor data of the one or more sensors that is detected before receiving the request to perform the operation satisfies a fourth set of one or more criteria different from the first set of one or more criteria, the second set of one or more criteria, and the third set of one or more criteria, forgoing performance of the operation; and in accordance with a determination that a fifth set of one or more criteria, different from the first set of one or more criteria, the second set of one or more criteria, the third set of one or more criteria, and the fourth set of one or more criteria, are satisfied, wherein the fifth set of one or more criteria include a criterion that is satisfied when the device is in a second orientation different from the first orientation, performing the operation.

In some embodiments, a non-transitory computer-readable storage medium storing one or more programs configured to be executed by one or more processors of a device that is communication with one or more sensors and one or more input devices is described. In some embodiments, the one or more programs includes instructions for: receiving a request to perform an operation; and in response to receiving the request to perform the operation: in accordance with a determination that a first set of one or more criteria are satisfied, wherein the first set of one or more criteria includes a first criterion that is satisfied when the device is in a first orientation, wherein the first set of one or more criteria include a second criterion that is satisfied when sensor data of the one or more sensors that is detected before receiving the request to perform the operation satisfies a second set of one or more criteria different from the first set of one or more criteria, performing the operation; in accordance with a determination that a third set of one or more criteria, different from the first set of one or more criteria and the second set of one or more criteria, are satisfied, wherein the third set of one or more criteria include the first criterion that is satisfied when the device is in the first orientation, wherein the third set of one or more criteria include a third criterion that is satisfied when the sensor data of the one or more sensors that is detected before receiving the request to perform the operation satisfies a fourth set of one or more criteria different from the first set of one or more criteria, the second set of one or more criteria, and the third set of one or more criteria, forgoing performance of the operation; and in accordance with a determination that a fifth set of one or more criteria, different from the first set of one or more criteria, the second set of one or more criteria, the third set of one or more criteria, and the fourth set of one or more criteria, are satisfied, wherein the fifth set of one or more criteria include a criterion that is satisfied when the device is in a second orientation different from the first orientation, performing the operation.

In some embodiments, a transitory computer-readable storage medium storing one or more programs configured to be executed by one or more processors of a device that is communication with one or more sensors and one or more input devices is described. In some embodiments, the one or more programs includes instructions for: receiving a request to perform an operation; and in response to receiving the request to perform the operation: in accordance with a determination that a first set of one or more criteria are satisfied, wherein the first set of one or more criteria includes a first criterion that is satisfied when the device is in a first orientation, wherein the first set of one or more criteria include a second criterion that is satisfied when sensor data of the one or more sensors that is detected before receiving the request to perform the operation satisfies a second set of one or more criteria different from the first set of one or more criteria, performing the operation; in accordance with a determination that a third set of one or more criteria, different from the first set of one or more criteria and the second set of one or more criteria, are satisfied, wherein the third set of one or more criteria include the first criterion that is satisfied when the device is in the first orientation, wherein the third set of one or more criteria include a third criterion that is satisfied when the sensor data of the one or more sensors that is detected before receiving the request to perform the operation satisfies a fourth set of one or more criteria different from the first set of one or more criteria, the second set of one or more criteria, and the third set of one or more criteria, forgoing performance of the operation; and in accordance with a determination that a fifth set of one or more criteria, different from the first set of one or more criteria, the second set of one or more criteria, the third set of one or more criteria, and the fourth set of one or more criteria, are satisfied, wherein the fifth set of one or more criteria include a criterion that is satisfied when the device is in a second orientation different from the first orientation, performing the operation.

In some embodiments, a device that is communication with one or more sensors and one or more input devices is described. In some embodiments, the device that is communication with one or more sensors and one or more input devices comprises one or more processors and memory storing one or more programs configured to be executed by the one or more processors. In some embodiments, the one or more programs includes instructions for: receiving a request to perform an operation; and in response to receiving the request to perform the operation: in accordance with a determination that a first set of one or more criteria are satisfied, wherein the first set of one or more criteria includes a first criterion that is satisfied when the device is in a first orientation, wherein the first set of one or more criteria include a second criterion that is satisfied when sensor data of the one or more sensors that is detected before receiving the request to perform the operation satisfies a second set of one or more criteria different from the first set of one or more criteria, performing the operation; in accordance with a determination that a third set of one or more criteria, different from the first set of one or more criteria and the second set of one or more criteria, are satisfied, wherein the third set of one or more criteria include the first criterion that is satisfied when the device is in the first orientation, wherein the third set of one or more criteria include a third criterion that is satisfied when the sensor data of the one or more sensors that is detected before receiving the request to perform the operation satisfies a fourth set of one or more criteria different from the first set of one or more criteria, the second set of one or more criteria, and the third set of one or more criteria, forgoing performance of the operation; and in accordance with a determination that a fifth set of one or more criteria, different from the first set of one or more criteria, the second set of one or more criteria, the third set of one or more criteria, and the fourth set of one or more criteria, are satisfied, wherein the fifth set of one or more criteria include a criterion that is satisfied when the device is in a second orientation different from the first orientation, performing the operation.

In some embodiments, a device that is communication with one or more sensors and one or more input devices is described. In some embodiments, the device that is communication with one or more sensors and one or more input devices comprises means for performing each of the following steps: receiving a request to perform an operation; and in response to receiving the request to perform the operation: in accordance with a determination that a first set of one or more criteria are satisfied, wherein the first set of one or more criteria includes a first criterion that is satisfied when the device is in a first orientation, wherein the first set of one or more criteria include a second criterion that is satisfied when sensor data of the one or more sensors that is detected before receiving the request to perform the operation satisfies a second set of one or more criteria different from the first set of one or more criteria, performing the operation; in accordance with a determination that a third set of one or more criteria, different from the first set of one or more criteria and the second set of one or more criteria, are satisfied, wherein the third set of one or more criteria include the first criterion that is satisfied when the device is in the first orientation, wherein the third set of one or more criteria include a third criterion that is satisfied when the sensor data of the one or more sensors that is detected before receiving the request to perform the operation satisfies a fourth set of one or more criteria different from the first set of one or more criteria, the second set of one or more criteria, and the third set of one or more criteria, forgoing performance of the operation; and in accordance with a determination that a fifth set of one or more criteria, different from the first set of one or more criteria, the second set of one or more criteria, the third set of one or more criteria, and the fourth set of one or more criteria, are satisfied, wherein the fifth set of one or more criteria include a criterion that is satisfied when the device is in a second orientation different from the first orientation, performing the operation.

In some embodiments, a computer program product is described. In some embodiments, the computer program product comprises one or more programs configured to be executed by one or more processors of a device that is communication with one or more sensors and one or more input devices. In some embodiments, the one or more programs include instructions for: receiving a request to perform an operation; and in response to receiving the request to perform the operation: in accordance with a determination that a first set of one or more criteria are satisfied, wherein the first set of one or more criteria includes a first criterion that is satisfied when the device is in a first orientation, wherein the first set of one or more criteria include a second criterion that is satisfied when sensor data of the one or more sensors that is detected before receiving the request to perform the operation satisfies a second set of one or more criteria different from the first set of one or more criteria, performing the operation; in accordance with a determination that a third set of one or more criteria, different from the first set of one or more criteria and the second set of one or more criteria, are satisfied, wherein the third set of one or more criteria include the first criterion that is satisfied when the device is in the first orientation, wherein the third set of one or more criteria include a third criterion that is satisfied when the sensor data of the one or more sensors that is detected before receiving the request to perform the operation satisfies a fourth set of one or more criteria different from the first set of one or more criteria, the second set of one or more criteria, and the third set of one or more criteria, forgoing performance of the operation; and in accordance with a determination that a fifth set of one or more criteria, different from the first set of one or more criteria, the second set of one or more criteria, the third set of one or more criteria, and the fourth set of one or more criteria, are satisfied, wherein the fifth set of one or more criteria include a criterion that is satisfied when the device is in a second orientation different from the first orientation, performing the operation.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a compute system in accordance with some embodiments.

FIGS. 1B-1G illustrate the use of Application Programming Interfaces (APIs) to perform operations in accordance with some embodiments.

FIG. 2 is a block diagram illustrating a device with interconnected subsystems in accordance with some embodiments.

FIG. 3 illustrates an example architecture of a device in accordance with some embodiments.

FIG. 4 illustrates an exemplary process for selectively performing operations based on device orientation and previous sensor data in accordance with some embodiments.

FIG. 5 is a flow diagram illustrating a process for disabling access to sensor data when a device is face down in accordance with some embodiments.

FIG. 6 is a flow diagram illustrating a process for managing processes in a containerized multiprocessor system that is in communication with sensors in accordance with some embodiments.

FIG. 7 is a flow diagram illustrating a process for performing an operation requiring sensor access based on an orientation of a device and previous sensor data in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

Processes described herein can include one or more steps that are contingent upon one or more conditions being satisfied. It should be understood that a process can occur over multiple iterations of the same process with different steps of the process being satisfied in different iterations. For example, if a process requires performing a first step upon a determination that a set of one or more criteria is met and a second step upon a determination that the set of one or more criteria is not met, a person of ordinary skill in the art would appreciate that the steps of the process are repeated until both conditions, in no particular order, are satisfied. Thus, a process described with steps that are contingent upon a condition being satisfied can be rewritten as a process that is repeated until each of the conditions described in the process are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a process until all of the conditions upon which steps in the process are contingent have been satisfied. A person having ordinary skill in the art would also understand that, similar to a process with contingent steps, a system or computer readable storage medium can repeat the steps of a process as many times as needed to ensure that all of the contingent steps have been performed.

Although the following description uses terms “first,” “second,” etc. to describe various elements, these elements should not be limited by the terms. In some embodiments, these terms are used to distinguish one element from another. For example, a first subsystem could be termed a second subsystem, and, similarly, a second subsystem device or a subsystem device could be termed a first subsystem device, without departing from the scope of the various described embodiments. In some embodiments, the first subsystem and the second subsystem are two separate references to the same subsystem. In some embodiments, the first subsystem and the second subsystem are both subsystems, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

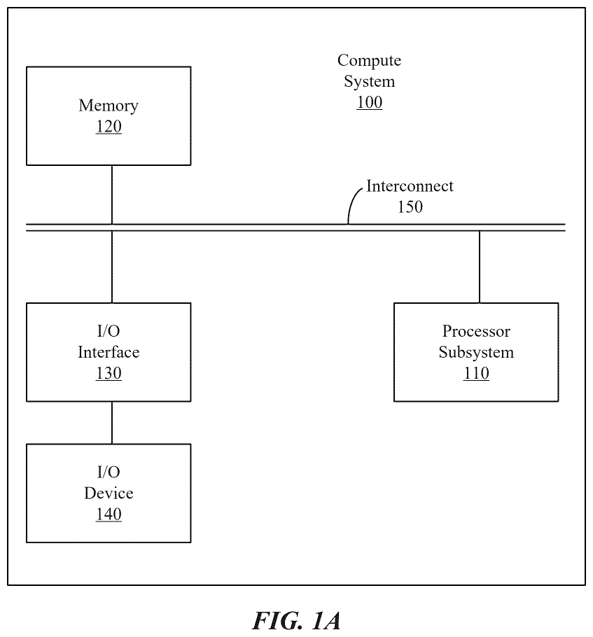

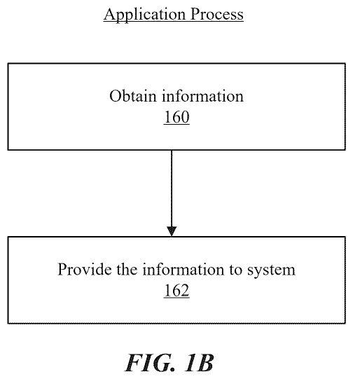

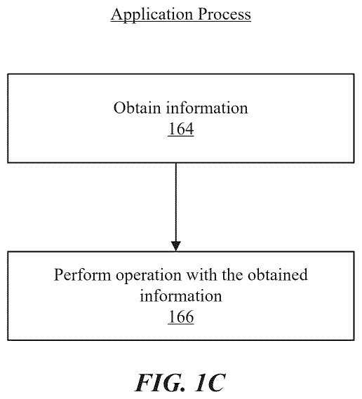

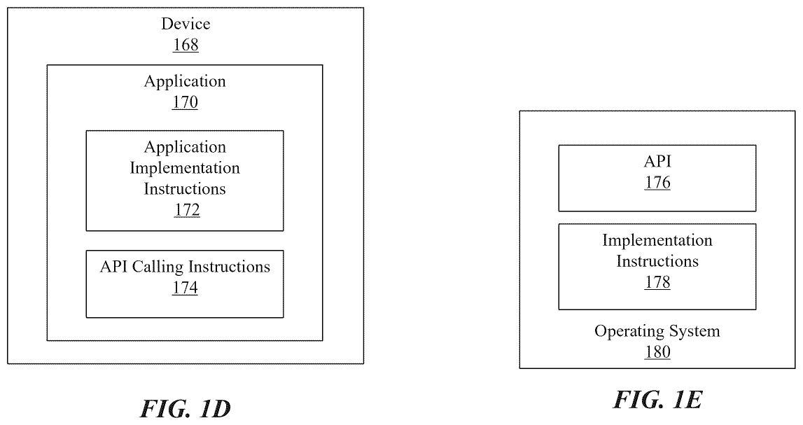

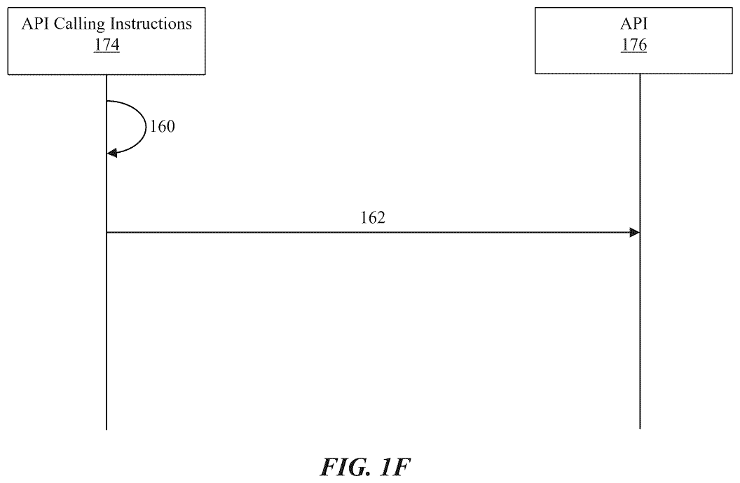

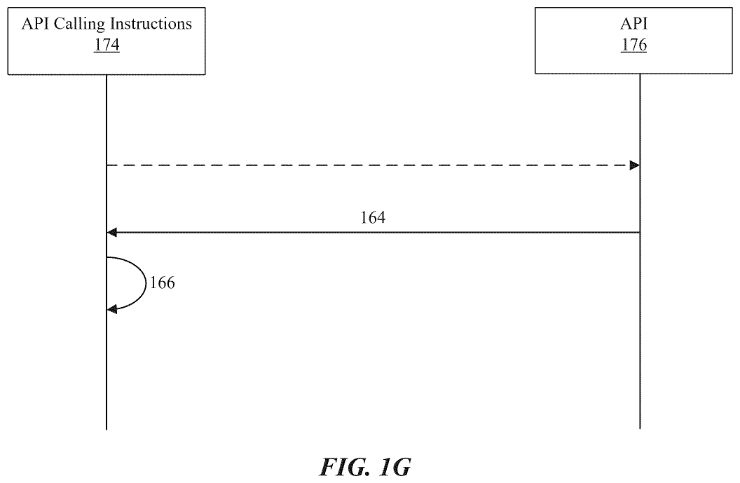

Turning to FIG. 1A, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some embodiments, compute system 100 is included or communicating with a physical component for the purpose of modifying the physical component in response to an instruction. In some embodiments, compute system 100 receives an instruction to modify a physical component and, in response to the instruction, causes the physical component to be modified. In some embodiments, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some embodiments, a sensor includes one or more hardware components that detect information about a physical environment in proximity to (e.g., surrounding) the sensor. In some embodiments, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. Although a single compute system is shown in FIG. 1A, compute system 100 can also be implemented as two or more compute systems operating together.

In some embodiments, processor subsystem 110 includes one or more processors or processing units configured to execute program instructions to perform functionality described herein. For example, processor subsystem 110 can execute an operating system, a middleware system, one or more applications, or any combination thereof.

In some embodiments, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive executive (AIX), network operating systems (e.g., Microsoft Windows Server), and real-time operating systems (e.g., QNX). In some embodiments, the operating system includes various procedures, sets of instructions, software components, and/or drivers for controlling and managing general system tasks (e.g., memory management, storage device control, power management, or the like) and for facilitating communication between various hardware and software components. In some embodiments, the operating system uses a priority-based scheduler that assigns a priority to different tasks that processor subsystem 110 can execute. In such examples, the priority assigned to a task is used to identify a next task to execute. In some embodiments, the priority-based scheduler identifies a next task to execute when a previous task finishes executing. In some embodiments, the highest priority task runs to completion unless another higher priority task is made ready.

In some embodiments, the middleware system provides one or more services and/or capabilities to applications (e.g., the one or more applications running on processor subsystem 110) outside of what the operating system offers (e.g., data management, application services, messaging, authentication, API management, or the like). In some embodiments, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some embodiments, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some embodiments, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some embodiments, the first node notifies the second node that the data has been stored in the memory by sending a pointer (e.g., a memory pointer, such as an identification of a memory location) to the second node so that the second node can access the data from where the first node stored the data. In some embodiments, the first node would send the data directly to the second node so that the second node would not need to access a memory based on data received from the first node.

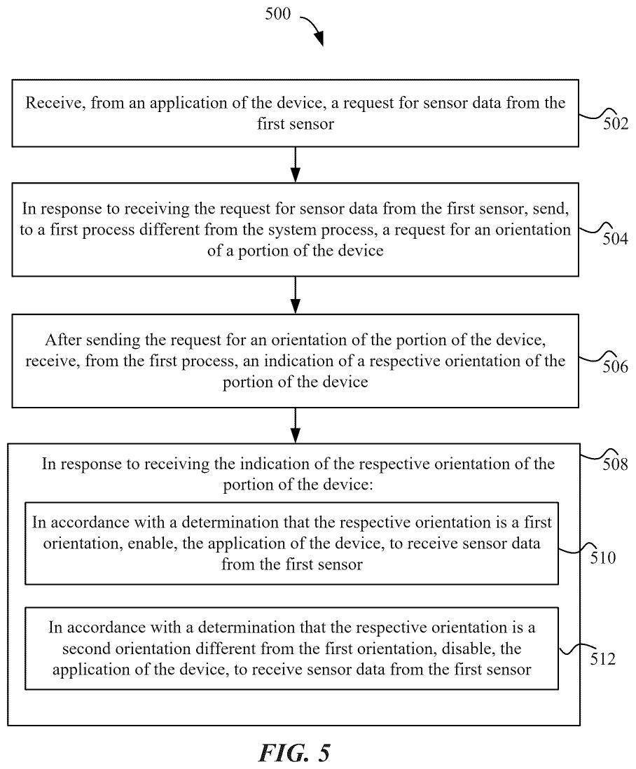

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with processes 500, 600, and 700 (FIGS. 5, 6, and 7) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some embodiments, these other forms of storage can also store program instructions executable by processor subsystem 110 to perform operations described herein. In some embodiments, processor subsystem 110 (or each processor within processor subsystem 110) contains a cache or other form of on-board memory.

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some embodiments, compute system 100 is communicating with a network via a network interface device (e.g., configured to communicate over Wi-Fi, Bluetooth, Ethernet, or the like). In some embodiments, compute system 100 is directly or wired to the network.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules, and/or components.

Implementations within the scope of the present disclosure include a computer-readable storage medium that encodes instructions organized as an application (e.g., application 170) that, when executed by one or more processing units, control an electronic device (e.g., device 168) to perform the process of FIG. 1B, the process of FIG. 1C, and/or one or more other processes and/or processes described herein.

It should be recognized that application 170 (e.g., illustrated in FIG. 1D) can be any suitable type of application, including, for example, one or more of: a browser application, an application that functions as an execution environment for plug-ins, widgets, or other applications, a fitness application, a health application, an accessory management application, a home application, a digital payments application, a media application, a social network application, a messaging application, and/or a maps application. In some embodiments, application 170 is an application that is pre-installed on device 168 at purchase (e.g., a first party application). In some embodiments, application 170 is an application that is provided to device 168 via an operating system update file (e.g., a first party application or a second party application). In other embodiments, application 170 is an application that is provided via an application store. In some embodiments, the application store can be an application store that is pre-installed on device 168 at purchase (e.g., a first party application store). In some embodiments, the application store is a third-party application store (e.g., an application store that is provided by another application store, downloaded via a network, and/or read from a storage device).

Referring to FIG. 1B and FIG. 1F, application 170 obtains information (e.g., 160). In some embodiments, at 160, information is obtained from at least one hardware component of device 168. In some embodiments, at 160, information is obtained from at least one software module (e.g., a set of one more instructions) of device 168. In some embodiments, at 160, information is obtained from at least one hardware component external to device 168 (e.g., a peripheral device, an accessory device, and/or a server). In some embodiments, the information obtained at 160 includes positional information, time information, notification information, user information, environment information, electronic device state information, weather information, media information, historical information, event information, hardware information, and/or motion information. In some embodiments, in response to and/or after obtaining the information at 160, application 170 provides the information to system (e.g., 162).

In some embodiments, the system (e.g., 180 as illustrated in FIG. 1E) is an operating system hosted on device 168. In some embodiments, the system (e.g., 180 as illustrated in FIG. 1E) is an external device (e.g., a server, a peripheral device, an accessory, and/or a personal computing device) that includes an operating system.

Referring to FIG. 1C, application 170 obtains information (e.g., 164). In some embodiments, the information obtained at 164 includes positional information, time information, notification information, user information, environment information electronic device state information, weather information, media information, historical information, event information, hardware information and/or motion information. In response to and/or after obtaining the information at 164, application 170 performs an operation with the information (e.g., 166). In some embodiments, the operation performed at 166 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 180 based on the information.

In some embodiments, one or more steps of the process of FIG. 1B and/or the process of FIG. 1C is performed in response to a trigger. In some embodiments, the trigger includes detection of an event, a notification received from system 180, a user input, and/or a response to a call to an API provided by system 180.

In some embodiments, the instructions of application 170, when executed, control device 168 to perform the process of FIG. 1B and/or the process of FIG. 1C by calling an application programming interface (API) (e.g., API 176) provided by system 180. In some embodiments, application 170 performs at least a portion of the process of FIG. 1B and/or the process of FIG. 1C without calling API 176.

In some embodiments, one or more steps of the process of FIG. 1B and/or the process of FIG. 1C includes calling an API (e.g., API 176) using one or more parameters defined by the API. In some embodiments, the one or more parameters include a constant, a key, a data structure, an object, an object class, a variable, a data type, a pointer, an array, a list or a pointer to a function or a process, and/or another way to reference a data or other item to be passed via the API.

Referring to FIG. 1D, device 168 is illustrated. In some embodiments, device 168 is a personal computing device, a smart phone, a smart watch, a fitness tracker, a head mounted display (HMD) device, a media device, a communal device, a speaker, a television, and/or a tablet. Device 168 includes application 170 and an operating system (not shown) (e.g., system 180 as illustrated in FIG. 1E). Application 170 includes application implementation instructions 172 and API calling instructions 174. System 180 includes API 176 and implementation instructions 178. It should be recognized that device 168, application 170, and/or system 180 can include more, fewer, and/or different components than illustrated in FIGS. 1D and 1E.

In some embodiments, application implementation instructions 172 is a software module that includes a set of one or more computer-readable instructions. In some embodiments, the set of one or more computer-readable instructions correspond to one or more operations performed by application 170. For example, when application 170 is a messaging application, application implementation instructions 172 can include operations to receive and send messages. In some embodiments, application implementation instructions 172 communicates with API calling instructions to communicate with system 180 via API 176 (e.g., as illustrated in FIG. 1E).

In some embodiments, API calling instructions 174 is a software module that includes a set of one or more computer-executable instructions.

In some embodiments, implementation instructions 178 is a software module that includes a set of one or more computer-executable instructions.

In some embodiments, API 176 is a software module that includes a set of one or more computer-executable instructions. In some embodiments, API 176 provides an interface that allows a different set of instructions (e.g., API calling instructions 174) to access and/or use one or more functions, processes, procedures, data structures, classes, and/or other services provided by implementation instructions 178 of system 180. For example, API calling instructions 174 can access a feature of implementation instructions 178 through one or more API calls or invocations (e.g., embodied by a function call, a method call, or a process call) exposed by API 176 and can pass data and/or control information using one or more parameters via the API calls or invocations. In some embodiments, API 176 allows application 170 to use a service provided by a Software Development Kit (SDK) library. In some embodiments, application 170 incorporates a call to a function or process provided by the SDK library and provided by API 176 or uses data types or objects defined in the SDK library and provided by API 176. In some embodiments, API calling instructions 174 makes an API call via API 176 to access and use a feature of implementation instructions 178 that is specified by API 176. In such embodiments, implementation instructions 178 can return a value via API 176 to API calling instructions 174 in response to the API call. The value can report to application 170 the capabilities or state of a hardware component of device 168, including those related to aspects such as input capabilities and state, output capabilities and state, processing capability, power state, storage capacity and state, and/or communications capability. In some embodiments, API 176 is implemented in part by firmware, microcode, or other low level logic that executes in part on the hardware component.

In some embodiments, API 176 allows a developer of API calling instructions 174 (which can be a third-party developer) to leverage a feature provided by implementation instructions 178. In such embodiments, there can be one or more sets of API calling instructions (e.g., including API calling instructions 174) that communicate with implementation instructions 178. In some embodiments, API 176 allows multiple sets of API calling instructions written in different programming languages to communicate with implementation instructions 178 (e.g., API 176 can include features for translating calls and returns between implementation instructions 178 and API calling instructions 174) while API 176 is implemented in terms of a specific programming language. In some embodiments, API calling instructions 174 calls APIs from different providers such as a set of APIs from an OS provider, another set of APIs from a plug-in provider, and/or another set of APIs from another provider (e.g., the provider of a software library) or creator of the another set of APIs.

Examples of API 176 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 168. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 178 is a system (e.g., an operating system and/or a server system) software module (e.g., a collection of computer-readable instructions) that is constructed to perform an operation in response to receiving an API call via API 176. In some embodiments, implementation instructions 178 is constructed to provide an API response (via API 176) as a result of processing an API call. By way of example, implementation instructions 178 and API calling instructions 174 can each be any one of an operating system, a library, a device driver, an API, an application program, or other module. It should be understood that implementation instructions 178 and API calling instructions 174 can be the same or different type of software module from each other. In some embodiments, implementation instructions 178 is embodied at least in part in firmware, microcode, or other hardware logic.

In some embodiments, implementation instructions 178 returns a value through API 176 in response to an API call from API calling instructions 174. While API 176 defines the syntax and result of an API call (e.g., how to invoke the API call and what the API call does), API 176 might not reveal how implementation instructions 178 accomplishes the function specified by the API call. Various API calls are transferred via the one or more application programming interfaces between API calling instructions 174 and implementation instructions 178. Transferring the API calls can include issuing, initiating, invoking, calling, receiving, returning, and/or responding to the function calls or messages. In other words, transferring can describe actions by either of API calling instructions 174 or implementation instructions 178. In some embodiments, a function call or other invocation of API 176 sends and/or receives one or more parameters through a parameter list or other structure.

In some embodiments, implementation instructions 178 provides more than one API, each providing a different view of or with different aspects of functionality implemented by implementation instructions 178. For example, one API of implementation instructions 178 can provide a first set of functions and can be exposed to third party developers, and another API of implementation instructions 178 can be hidden (e.g., not exposed) and provide a subset of the first set of functions and also provide another set of functions, such as testing or debugging functions which are not in the first set of functions. In some embodiments, implementation instructions 178 calls one or more other components via an underlying API and thus be both an API calling instructions and an implementation instructions. It should be recognized that implementation instructions 178 can include additional functions, processes, classes, data structures, and/or other features that are not specified through API 176 and are not available to API calling instructions 174. It should also be recognized that API calling instructions 174 can be on the same system as implementation instructions 178 or can be located remotely and access implementation instructions 178 using API 176 over a network. In some embodiments, implementation instructions 178, API 176, and/or API calling instructions 174 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

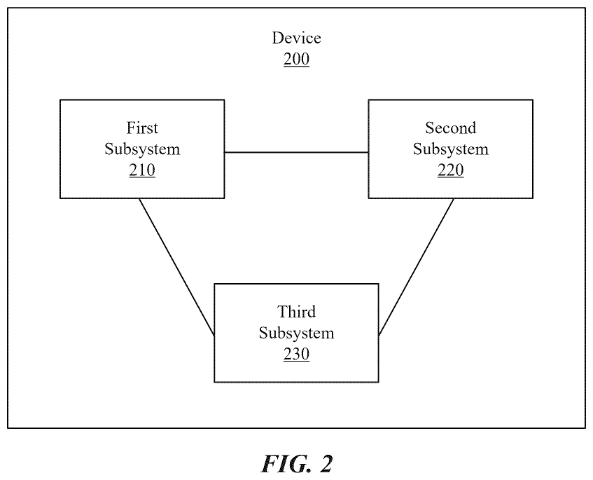

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1A (i.e., compute system 100). Although three subsystems are shown in FIG. 2, device 200 can include more or fewer subsystems.

In some embodiments, some subsystems are not connected to other subsystem (e.g., first subsystem 210 can be connected to second subsystem 220 and third subsystem 230 but second subsystem 220 cannot be connected to third subsystem 230). In some embodiments, some subsystems are connected via one or more wires while other subsystems are wirelessly connected. In some embodiments, messages are set between the first subsystem 210, second subsystem 220, and third subsystem 230, such that when a respective subsystem sends a message the other subsystems receive the message (e.g., via a wire and/or a bus). In some embodiments, one or more subsystems are wirelessly connected to one or more compute systems outside of device 200, such as a server system. In such examples, the subsystem can be configured to communicate wirelessly to the one or more compute systems outside of device 200.

In some embodiments, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some embodiments, device 200 is configured to navigate (with or without user input) in a physical environment.

In some embodiments, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some embodiments, at least a portion of device 200 functions as a distributed compute system. For example, a task can be split into different portions, where a first portion is executed by first subsystem 210 and a second portion is executed by second subsystem 220.

Attention is now directed towards techniques for disabling access to sensor data. Such techniques are described in the context of a multiprocessor device with a compartmentalized architecture for enhancing sensor data security and/or user privacy. It should be recognized that other types of processor architectures can be used with techniques described herein. For example, a single processor can manage sensor data using techniques described herein. In addition, techniques optionally complement or replace other techniques for disabling access to sensor data.

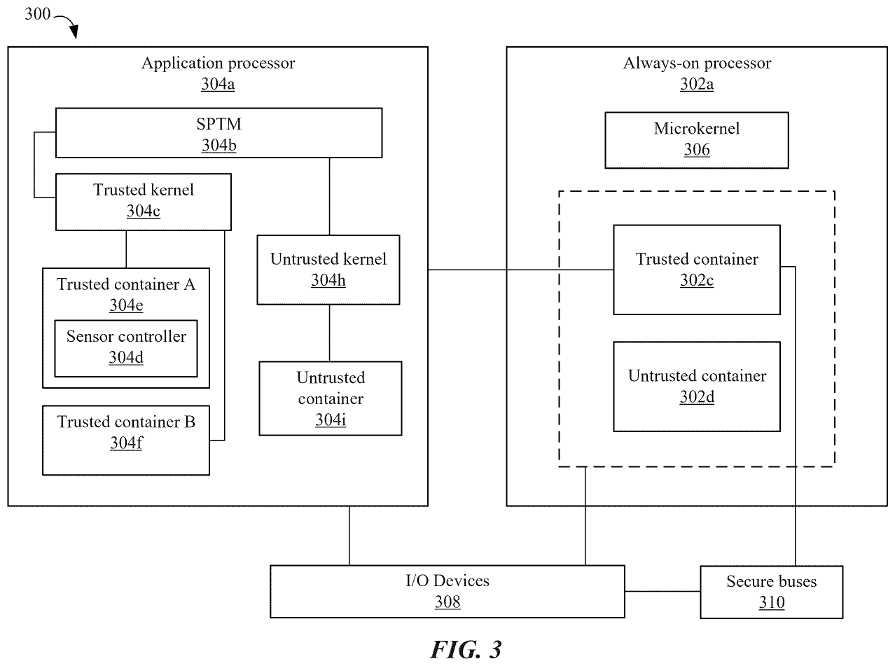

FIG. 3 illustrates an example architecture of a device in accordance with some embodiments. As illustrated in FIG. 3, device 300 includes application processor 302a and always-on processor 302b. In some embodiments, application processor 302a is a main CPU of device 300 that runs an operating system and/or one or more user applications while always-on processor 302b is a co-processor designed for low-power operations and/or specialized tasks. In some embodiments, application processor 302a and always-on processor 302b are separate physical processors. In other embodiments, application processor 302a and always-on processor 302b are different cores within a single processor. It should be recognized that application processor 302a and/or always-on processor 302b can be other types of processors than described above.

In some embodiments, device 300 includes Secure Page Table Monitor (SPTM) 304b. SPTM 304b can be implemented in software and/or hardware. In some embodiments, SPTM 304b is executed on application processor 302a. In other embodiments, SPTM 304b is executed on always-on processor 302b or on a separate processor different from application processor 302a and always-on processor 302b. In some embodiments, SPTM 304b is responsible for managing memory access across processes running on device 300 (e.g., on application processor 302b, always-on processor 302b, and/or another processor different from application processor 302b and always-on processor 302). For example, SPTM 304b can allow for granular control over memory access to enhance security and/or isolation of different processes, environments, and/or applications within device 300.

In some embodiments, the architecture of device 300 provides a compartmentalized approach to securing sensor data using a combination of hardware separation (e.g., separate processors and/or isolated memory regions), memory management (e.g., SPTM 304b), and/or software isolation (e.g., trusted kernel 304c, microkernel 306, and/or trusted containers) to provide security guarantees while still allowing for efficient processing of sensor data. In some embodiments, SPTM 304b monitors and/or controls memory access attempts, validates permissions, updates page tables, manages a mapping of virtual memory addresses to physical memory addresses for processes and/or containers, and/or manages device address resolution tables as necessary to maintain (1) integrity of memory boundaries between different components (e.g., processes and/or containers) and/or (2) isolation between different memory spaces and/or enforce access controls. For example, if a trusted container needs to access sensor data, SPTM 304b can manage appropriate memory mappings to ensure that data is accessible only to authorized processes within the trusted container. In some embodiments, if one layer of security is compromised, other layers can still provide protection. For example, even if an attacker manages to compromise untrusted kernel 304h, SPTM 304b, operating at a higher privilege level, can still enforce memory access controls to help prevent direct access to the trusted container.

In some embodiments, SPTM 304b includes a memory management process that divides a memory space of application processor 302a into two distinct domains: a trusted domain and an untrusted domain. In some embodiments, the trusted domain is managed by trusted kernel 304c while the untrusted domain is managed by untrusted kernel 304h. In some embodiments, trusted kernel 304c is responsible for managing the trusted domain of application processor 302a. For example, trusted kernel 304c can create and/or manage multiple trusted containers (e.g., trusted container A 304c and/or trusted container B 304f) within the trusted domain. In some embodiments, each trusted container is isolated from other containers and/or has its own set of permissions and/or access rights. In some embodiments, the containerization approach managed by SPTM 304b via trusted kernel 304c allows for granular security controls and/or isolation between different secure processes, containers, environments and/or components of application processor 302a.

In some embodiments, the trusted containers (e.g., trusted container A 304e and/or trusted container B 304f) host one or more processes and/or applications. For example, one trusted container can host a secure cryptographic application while another trusted container can host a secure biometric authentication application. In some embodiments, the isolation between the trusted containers ensures that even if a process and/or application in trusted container A 304c is compromised, security and/or integrity of processes and/or applications in trusted container B 304f and/or other trusted containers in the trusted domain of application processor 302a remain protected. In some embodiments, trusted kernel 304c implements a capability-based security model. In the capability-based security model, each trusted container is granted specific capabilities that define what resources it can access and what operations it can perform. In some embodiments, the capability-based security model can follow a principle of least privilege, which ensures that each container has only permissions necessary for its intended functionality to minimize the potential impact of a breach.

As illustrated in FIG. 3, application processor 304a includes sensor controller 304d within trusted container A 304c. In some embodiments, sensor controller 304d implements one or more algorithms and/or executes one or more processes for managing sensor data and/or enforcing security policies related to sensor data. For example, sensor controller 304d can control whether an application process in untrusted container 304i (e.g., as discussed further below) is allowed to receive sensor data from a camera or microphone based on a current state of device 300 (e.g., with its display facing-down or facing-up). In some embodiments, sensor controller 304d manages the relationship between sensor states and/or device indicators to ensure that a sensor indication matches an actual sensor state, such as communicating with other components to control hardware indicators (e.g., controlling a light indicating an on or off state of the camera). In some embodiments, sensor controller 304d processes data received from trusted container 302c of always-on processor 302b, which can interface with one or more input and/or output devices via a secure bus as described further below.

In some embodiments, untrusted kernel 304h manages the untrusted domain of application processor 304a. For example, untrusted kernel 304h can create and/or manage one or more untrusted containers (e.g., untrusted container 304i) within the untrusted domain. In some embodiments, untrusted container 304i hosts user processes and/or applications that do not require high levels of security (e.g., sometimes referred to as application processes, user processes, applications, and/or user applications). For example, untrusted container 304i can host web browsers, media players, and/or other user facing applications. In some embodiments, untrusted container 304i hosts background processes for synchronizing data, updating software, and/or managing device settings that do not involve sensitive data and/or access such as with respect to device sensor data. In some embodiments, the separation between the trusted domain and the untrusted domain ensures that potentially vulnerable user facing applications and/or services cannot directly access sensitive data and/or operations in the trusted domain.

In some embodiments, untrusted kernel 304h is a full-featured operating system kernel, providing services and/or APIs for user applications. In some embodiments, untrusted kernel 304h allows for compatibility with existing applications and/or development paradigms while still maintaining a secure architecture through memory management enforced by SPTM 304b and/or process separation managed by untrusted kernel 304h itself.

In some embodiments, always-on processor 302a is divided into two containers: trusted container 302c and untrusted container 302d. In some embodiments, the division is implemented by SPTM 304b via microkernel 306. In some embodiments, trusted container 302c of always-on processor 302b hosts secure processes and/or sensitive algorithms with access to hardware and/or sensor data of device 300 while untrusted container 302d hosts less sensitive processes not requiring access to hardware and/or sensor data of device 300. In some embodiments, microkernel 306 is same type of kernel (e.g., a microkernel) as trusted kernel 304c but a different type of kernel than untrusted kernel 304h.

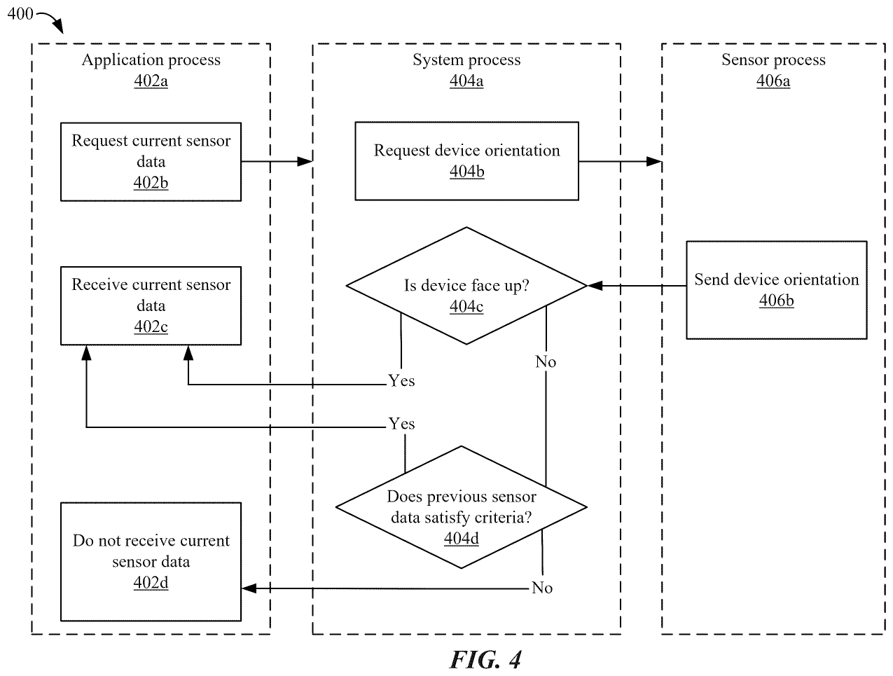

In some embodiments, the division of always-on processor 302a into trusted container 302c and untrusted container 302d allows for task distribution while maintaining security and/or implementing always-on features that require frequent monitoring and/or processing. For example, trusted container 302c can securely receive and/or process data from one or more input and/or output devices via a secure bus (e.g., as described further below) while untrusted container 302d can handle less sensitive tasks such as power management and/or non-sensitive background operations. This architecture can ensure that sensitive data and/or operations remain within trusted container 302c while still allowing device 300 to maintain responsiveness and/or power efficiency. In some embodiments, for more complex processing and/or policy decisions such as process 400 as described with respect to FIG. 4, trusted container 302c can securely signal application processor 302a and/or communicate with its trusted containers (e.g., trusted container A 304c and/or trusted container B 304f) via secure Inter-Process Communication (IPC) messages managed by SPTM 304b.

In some embodiments, device 300 includes one or more input and output devices (I/O devices) 308, such as an Inertial Measurement Unit (IMU), an infrared proximity sensor, and/or a gyroscope. In some embodiments, secure buses 310 are one or more dedicated buses that provide a protected communication between I/O devices 308 and trusted container 302c of always-on processor 302a. In some embodiments, the use of secure buses 310 for I/O devices 308 ensures that raw sensor data is only accessible to the trusted containers and/or to enforce hardware-level access controls to enhance the security of a path of the raw sensor data. In some embodiments, one or more I/O devices of I/O devices 308 are connected to and/or can communicate data with other components of device 300 via secure buses 310 while one or more other I/O devices of I/O devices 308 are connected to and/or communicate data directly with other components of device 300 without passing through secure buses 310 and/or always-on processor 302a. In some embodiments, a direct communication path allows for efficient handling of high-bandwidth and/or latency-sensitive sensor data that does not require additional security measures provided by secure buses 310 and/or trusted container 302c. For example, audio data from a microphone and/or touch input data from a touch-sensitive screen can be sent directly to application processor 304a.

In some embodiments, the architecture of device 300 allows for secure processing of sensor data. For example, data from I/O devices 308 (e.g., IMU and/or proximity sensor) can be sent to trusted container 302c of always-on processor 302b via secure buses 310. This data can then be sent to and processed by sensor controller 304d within trusted container A 304c of application processor 304a. In some embodiments, the secure processing of sensor data within sensor controller 304d allows for the implementation of privacy-preserving features, where raw sensor data is processed locally and only derived, less sensitive data is then shared with other processes and/or components of device 300. In some embodiments, the processed sensor data and/or derived data can be selectively shared with other components of device 300. For example, sensor controller 304d can enable certain data to be shared with trusted container B 304f and/or untrusted container 304i on application processor 304b via a secure communication channel (e.g., IPC messages) managed by SPTM 304b and/or trusted kernel 304c. In some embodiments, selectively sharing processed sensor data allows for a balance between security and/or functionality, where sensitive raw data and/or processing algorithms can be kept secure within trusted container 302c while still allowing other components of device 300 to benefit from the processed results. For example, a face-down detection algorithm can run in trusted container 302c, with only a binary result and/or read-only data (e.g., device 300 being face-down or not face-down) being shared with other components such as sensor controller 304d, trusted container B 304f, and/or untrusted container 302d. In some embodiments, the results of such secure processing (e.g., whether device 300 is face-down or face-up) is securely communicated to a policy enforcement component (e.g., sensor controller 304d) running in one of the trusted containers (e.g., 304c) or in a different component of the trusted domain on application processor 302a. In some embodiments, the policy enforcement component (e.g., sensor controller 304d) then makes decisions about allowing or disallowing certain operations (e.g., activating the camera and/or microphone) based on the securely processed sensor data. The separation of sensor data processing (e.g., in trusted container 302c) from policy enforcement via sensor controller 304d can provide an additional layer of security and/or allow for complex sensor policy decisions to be made based on different inputs while keeping raw sensor data and/or processing algorithms secure.

In some embodiments, communication between different trusted containers, such as between trusted container 302c on always-on processor 302a and trusted containers A 304e and B 304f on application processor 304a, is facilitated by an Inter-Process Communication (IPC) mechanism. The IPC mechanism can be implemented and managed by SPTM 304b, microkernel 306, and/or trusted kernel 304c to ensure that communication between trusted containers remains secure. For example, the IPC mechanism can use cryptographic techniques to ensure security and/or integrity of communications between trusted containers. In some embodiments, the IPC mechanism can include metadata to identify source and/or destination containers for each communication. In some embodiments, for certain types of sensor data and/or security-critical data, the IPC mechanism implements a one-way communication channel, where data can only flow from a more privileged container to a less privileged one. For example, when transferring sensor data from trusted container 302c to trusted container A 304e, the data can be encrypted, signed, and then placed in a shared memory buffer. SPTM 304b can then manage the access permissions, ensuring that only the intended recipient (e.g., trusted container A 304c) can read from this buffer. In some embodiments, SPTM 304b logs IPC messages for auditing purposes, by recording details such as containers involved, type of data transferred, and/or timestamp.

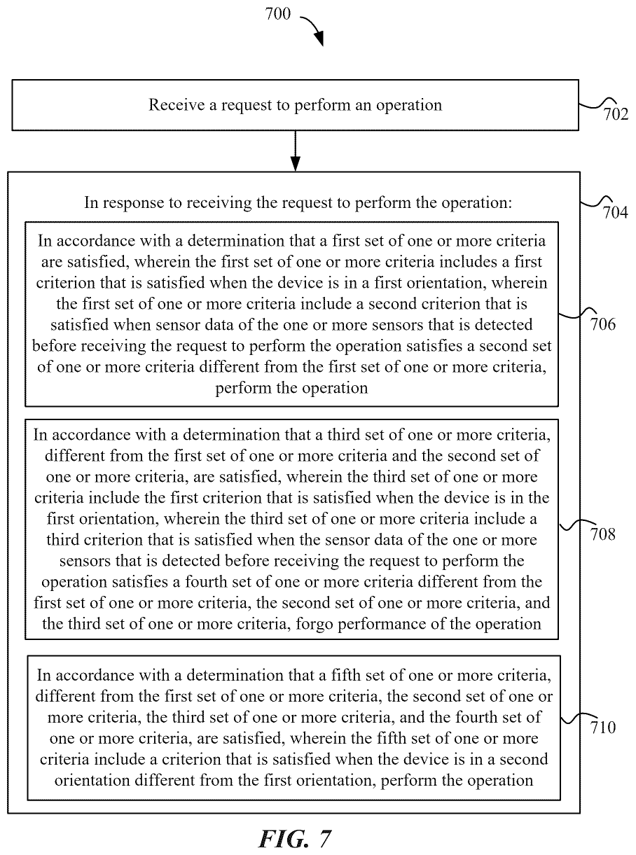

FIG. 4 illustrates an exemplary process for selectively performing operations based on device orientation and previous sensor data in accordance with some embodiments. The exemplary process is used to illustrate the processes described below, including the processes in FIGS. 5 and 7. It should be recognized that some steps of the exemplary process are, optionally, combined, changed, and/or omitted.

In some embodiments, process 400 includes sensor process 406a that is running in a trusted container (e.g., trusted container 302c) of a first processor (e.g., always-on processor 302a), system process 404a (e.g., sensor controller 304d) that is running in a trusted container (e.g., trusted container 304c) of a second processor (e.g., application processor 304a), and application process 402a that is running in an untrusted container (e.g., untrusted container 304i) of the second processor. In some embodiments, sensor process 406a is a process responsible for collecting and processing data from sensors (e.g., I/O devices 308) of a device (e.g., device 300), such as an inertial measurement unit (IMU) sensor, an infrared proximity sensor, a camera, and/or a microphone. In some embodiments, system process 404a is an operating system process that manages communication between applications and hardware components and can include components such as a policy enforcement component (e.g., sensor controller 304d), which ensures that sensor indication matches a sensor state. In some embodiments, application process 402a is a user application, such as a third-party application downloaded from an application store and/or a native application of the device.

In some embodiments, process 400 begins when application process 402a sends (e.g., 402b) a request for current sensor data to system process 404a. For example, application process 402a can request access to camera data and/or audio data. In some embodiments, the request to perform the operation is sent from untrusted container 304i to trusted container 304e via an Inter-Process Communication. In some embodiments, the request for current sensor data corresponds to a request to perform an operation. In some embodiments, sensor controller 304d in trusted container 304e receives and/or processes the request for current sensor data. For example, application process 402a can receive the request to perform the operation and, in response, send the request for current sensor data. In such an example, the request for the operation can be a request to initiate a video stream, initiate an audio stream, open a camera application and/or initiate a video call.

In some embodiments, after receiving the request for current sensor data, system process 404a sends (e.g., 404b) a request for device orientation to sensor process 406a. This step corresponds to system process 404a sending a request for a current orientation of the device to another process. In some embodiments, the request for the current orientation of the device is sent from trusted container A 304e on application processor 304a to trusted container 302c on always-on processor 302 a, using a secure Inter-Process Communication. In some embodiments, sensor process 406a determines the current orientation of the device using data from one or more sensors, such as an infrared sensor, an Inertial Measurement Unit (IMU) sensor, and/or an accelerometer. In some embodiments, data from the one or more sensors is communicated from I/O devices 308 to trusted container 302c via dedicated secure buses 310. For example, sensor process 406a can determine if the device is face up, face down, or in a specific angular orientation. In some embodiments, sensor process 406a can use a combination of sensor data from sensors, such as the IMU sensor and the infrared sensor, to determine the current orientation of the device (e.g., being face down on a surface) with a higher confidence, while in other embodiments, sensor process 406a can use sensor data from one of the sensors to determine the current orientation of the device with a lower latency.

In some embodiments, after determining the device orientation, sensor process 406a sends (e.g., 406b) the device orientation back to system process 404a. In some embodiments, the device orientation is transmitted from trusted container 302c on always-on processor 302 to trusted container A 304c on application processor 304 via an Inter-Process Communication. This step corresponds to system process 404a receiving an indication of the current orientation of the device. The device orientation information can include specific angular measurements or predefined binary values such as “face up” or “face down”.

In some embodiments, system process 404a evaluates (e.g., 404c) whether the device is face up at 404c. This decision point corresponds to the determination of whether the device is in a first orientation (e.g., face up) or a second orientation (e.g., face down). For example, if the device is determined to be face up, the process moves to step 402c. For another example, if the device is determined to be face down, the process moves to step 404d.

In some embodiments, when the device is determined to be face up, system process 400 checks (e.g., 404d) whether previous sensor data satisfies a set of one or more criteria. This step corresponds to the determination of whether previous sensor data detected before receiving the request for current sensor data satisfies the set of one or more criteria to allow performing step 402c. In some embodiments, sensor controller 304d performs a determination of whether previous sensor data satisfies the set of one or more criteria. For example, system process 404a can check if the device has detected a high amount of motion or acceleration within a specific period of time, corresponding to a critical event such as a car crash. For another example, system process 404a can check if audio input, such as a voice command and/or a specific sound pattern, has been detected that can also correspond to an event such as a car crash. In some embodiments, the audio input is received directly by application processor 304a from I/O devices 308, bypassing secure buses 310 and always-on processor 302a.

In some embodiments, if the previous sensor data satisfies the set of one or more criteria, system process 400 receives (e.g., 402c) current sensor data. This step corresponds to enabling application process 402a to receive the current sensor data when the current orientation is a face up orientation or when the current orientation is face down orientation while the set of one or more criteria is satisfied (e.g., other sensor data such as motion and/or audio point to a critical event such as a car crash). For example, if the set of one or more criteria is satisfied, system process 404a can allow application process 402a to access the current sensor data. In some embodiments, SPTM 304b manages memory access to allow application process 402a in untrusted container 304i to access the current sensor data.

In some embodiments, if the device is determined to be face down and if the previous sensor data does not satisfy the set of one or more criteria, system process 404a does not receive (e.g., 402d) current sensor data. This step corresponds to disabling application process 402a from receiving current sensor data when the current orientation of the device is determined to be face down and when the set of one or more criteria are not satisfied (e.g., no car crash detected via sensors of device 300). For example, if the device is face down, system process 404a can deny the request for current sensor data from application process 402a to enforce security and/or privacy. For another example, if the previous sensor data does not meet specific motion and/or audio criteria, system process 404a can disable certain device features including sending an error message to application process 402a (e.g., a vector of zeroes, and empty message, and/or an error status). The decision to not provide current sensor data when the device is face down and when the set of one or more criteria are not satisfied prevents any application from stealthily accessing sensitive sensors such as the camera and/or microphone when the user might not be aware and/or block scenarios where a malicious application might try to gather data without the user's knowledge and/or consent.

In some embodiments, process 400 includes additional steps not explicitly illustrated in FIG. 4. For example, while disabling application process 402a from receiving current sensor data, system process 404a can monitor the device orientation. If a change from face down to face up is detected, system process 404a can then enable application process 402a to receive current sensor data.

In some embodiments, system process 404a differentiates between types of applications and/or sensors. For example, a system application (such as a virtual assistant) can always be enabled to receive current sensor data regardless of the device orientation. Similarly, certain sensors (e.g., an accelerometer) might always provide data regardless of orientation, while others (e.g., a camera and/or microphone) can be subject to the orientation-based restrictions.

In some embodiments, system process 404a can also control other device functions based on the orientation and/or sensor data of the device. For example, when the device is determined to be face up and the set of one or more criteria are satisfied, system process 404a can cause a light on the device to be turned on. Conversely, when an application is not requesting sensor data, system process 404a can cause the light to be turned off via the policy enforcement component (e.g., sensor controller 304d).

In some embodiments, process 400 allows the device to implement context-aware functionality that balances user convenience with privacy and/or security concerns. For example, the device might only allow access to the camera when it is face up and/or when it is face down but has detected a user interaction within a threshold period of time (e.g., few seconds and/or minutes) to prevent unauthorized sensor and/or sensitive data access. For another example, the device might activate emergency features if it detects a sudden impact while face down that potentially indicates a car crash, even if the device would normally not allow sensor access in that orientation. This process demonstrates how the device can selectively enable or disable access to sensor data or perform certain operations based on a combination of a physical orientation of device 300 and/or timely analysis of sensor data.

In some embodiments, system process 404a does not request orientation when an application is actively receiving sensor data. In such embodiments, system process 404a allows the sensor data to continue to be provided to the application without checking a current orientation and/or whether an orientation has changed.

FIG. 5 is a flow diagram illustrating a process (e.g., process 500) for disabling access to sensor data when a device is face down in accordance with some embodiments. Some operations in process 500 are, optionally, combined, the orders of some operations are, optionally, changed, and some operations are, optionally, omitted.

As described below, process 500 provides an intuitive way for disabling access to a sensor when a device is face down. Process 500 reduces the cognitive burden on a user, thereby creating a more efficient human-machine interface. For battery-operated computing devices, enabling a user to interact with such devices faster and more efficiently conserves power and increases the time between battery charges.

In some embodiments, process 500 is performed at a device (e.g., 300), by a system process (e.g., 304d and/or 404a) (e.g., an operating system process, a sensor controller, an output controller, and/or an indicator controller) of the device, that is in communication with (and/or includes) a first sensor (e.g., a camera, a depth sensor, a microphone, a hardware input mechanism, a rotatable input mechanism, a physical input mechanism, a button, a crown, a knob, a dial, a physical slider, an accelerometer, a mouse, a keyboard, a touchpad, and/or a touch-sensitive surface) (e.g., 308). In some embodiments, the system process is part of and/or executing on behalf of an operating system (e.g., 304c) of the device. In some embodiments, the system process facilitates communication between one or more applications (e.g., 402a) of the device and one or more hardware components of the device. In some embodiments, the system process facilitates communication with secure processes and/or hardware-based processes (e.g., processes active while the device is locked and/or processes seeking to access a hardware component of the device). In some embodiments, the device is a watch, a phone, a tablet, a fitness tracking device, a processor, a head-mounted display (HMD) device, a communal device, a media device, a speaker, a television, an electronic device, and/or a personal computing device.

The system process receives (502), from an application (e.g., 402a) (e.g., a home application, a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application) of the device (e.g., installed and/or running on the device), a request for sensor data (e.g., 404a receiving request as a result of 402b) (e.g., raw sensor data, sensor metadata, image data, video data, and/or audio data) from (e.g., corresponding to, of, associated with, and/or related to) the first sensor.

In response to receiving the request for sensor data from the first sensor, the system process sends (504), to a first process (e.g., 406a) (e.g., of the device and/or another device different from the device) different from the system process (and/or a process hosting a portion of the application), a request for an orientation (e.g., current orientation, such as an angle and/or direction) of a portion (e.g., a portion that physically includes the first sensor, an output device, and/or an input device) of the device (e.g., 404b). In some embodiments, the output device includes a display generation component, an audio generation component, and/or a haptic generation component. In some embodiments, the input device includes a camera, a depth sensor, a microphone, a hardware input mechanism, a rotatable input mechanism, a physical input mechanism, a button, a crown, a knob, a dial, a physical slider, an accelerometer, a mouse, a keyboard, a touchpad, and/or a touch-sensitive surface.

After (e.g., as a result of and/or as a response to) sending the request for an orientation of the portion of the device, the system process receives (506), from the first process, an indication of a respective orientation of the portion of the device (e.g., 404a receiving device orientation as a result of 406b).

In response to (508) receiving the indication of the respective orientation of the portion of the device, in accordance with a determination that the respective orientation is a first orientation (e.g., face up, facing a first direction, and/or an unobstructed orientation), the system process enables (510), the application of the device, to receive sensor data from the first sensor (e.g., as described with respect to 402c). In some embodiments, enabling, the application, to receive sensor data from the first sensor includes requesting and/or obtaining sensor data from the first sensor.

In response to (508) receiving the indication of the respective orientation of the portion of the device, in accordance with a determination that the respective orientation is a second orientation (e.g., face down, facing a second direction different from the first direction, and/or an obstructed orientation) different from the first orientation, the system process disables (512), the application of the device, to receive sensor data from the first sensor (e.g., as described with respect to 402d). In some embodiments, disabling, the application, to receive sensor data from the first sensor includes forgoing request and/or obtainment of sensor data from the first sensor. In some embodiments, disabling, the application, to receive sensor data from the first sensor includes sending, to the application, an indication that the application is not able to currently receive sensor data from the first sensor. In some embodiments, disabling, the application, to receive sensor data from the first sensor includes requesting and/or attempting obtainment of sensor data from the first sensor. In some embodiments, disabling, the application, to receive sensor data from the first sensor includes receiving, from the first sensor and/or another process, an indication that the application is not able to currently receive sensor data from the first sensor.

In some embodiments, the first sensor includes (and/or is) a camera. In some embodiments, the camera is a front facing camera. In some embodiments, the camera is a rear-facing camera. In some embodiments, the first sensor includes (and/or is) a microphone.

In some embodiments, the application (e.g., 402a) is a user application. In some embodiments, the user application is a client application that uses the system process to perform one or more operations. In some embodiments, the user application is an application executing in a user space (e.g., and not a kernel space). In some embodiments, the user application is an application capable of detecting and/or receiving input and/or requests from a user. In some embodiments, the user application is a first-party application (e.g., part of an operating system of the device), a second-party application (not part of an operating system of the device but developed by an organization that created the operating system of the device, or a third-party application (e.g., installed via an application store)). In some embodiments, the user application uses sensor data from the first sensor for providing one or more features of the user application.

In some embodiments, the system process (e.g., 404a) is executing on a first processor (e.g., 304a) (e.g., always-on processor, co-processor, low-power processor, and/or specialized processor). In some embodiments, the first process is executing on a second processor (e.g., 302a) (e.g., application processor, main CPU, general-purpose processor, and/or high-performance processor) different (and/or separate) from the first processor. In some embodiments, the first processor includes a trusted container (e.g., 304e) running the system process. In some embodiments, the second processor is the main processor of the device that is running one or more user applications (e.g., application of the device) (e.g., 304a) in an untrusted container (e.g., 304i). In some embodiments, the first processor and the second processor communicate via an Inter-Process Communication mechanism.

In some embodiments, in response to receiving the indication of the respective orientation of the portion of the device (e.g., 406b), in accordance with the determination that the respective orientation is the first orientation (e.g., face up, facing a first direction, and/or an unobstructed orientation), the system process causes a light, of the device, to be turned on (and/or activates a light of the device). In some embodiments, enabling, the application of the device, to receive sensor data from the first sensor includes causing the light, of the device, to be turned on. In some embodiments, in response to receiving the indication of the respective orientation of the portion of the device, in accordance with the determination that the respective orientation is the second orientation (e.g., face down, facing a second direction different from the first direction, and/or an obstructed orientation), the system process forgoes causing the light, of the device, to be turned on (and/or forgoes activating the light of the device and/or deactivates the light of the device). In some embodiments, disabling, the application of the device, to receive sensor data from the first sensor includes forgoing causing the light, of the device, to be turned on.

In some embodiments, before (and/or after) receiving the request for sensor data from the first sensor (e.g., 404a receiving request as a result of 402b) and in accordance with a determination that sensor data from the first sensor is not being provided to an application (e.g., of the device and/or another device different from the device), the system process causes the light, of the device, to be turned off (and/or deactivates the light of the device). In some embodiments, before and/or after receiving the request for sensor data from the first sensor and in accordance with a determination that sensor data from the first sensor is not being provided to the application of the device (and/or the application of the device did not request sensor data from the first sensor), the system process causes the light, of the device, to be turned off (and/or deactivates the light of the device).

In some embodiments, enabling, the application (e.g., 402a) of the device, to receive sensor data from the first sensor includes sending, to the application of the device, sensor data from the first sensor (e.g., as described with respect to 402c). In some embodiments, sending, to the application of the device, sensor data from the first sensor includes sending an Inter-Process Communication with sensor data from the first sensor from a first processor (e.g., 304a) that is running the system process to a second processor (e.g., 304a) that is running the application of the device.

In some embodiments, disabling, the application (e.g., 402a) of the device, to receive sensor data from the first sensor includes sending, to the application of the device, an error message (e.g., permission error, security policy violation, access denied message, and/or sensor unavailable message) (e.g., as described with respect to 402d). In some embodiments, the error message is sent via an Inter-Process Communication between a first processor running the system process and a second processor running the application of the device.

In some embodiments, disabling, the application (e.g., 402a) of the device, to receive sensor data from the first sensor includes sending, to the application of the device, predefined data (e.g., vector of 0's and/or null values) (e.g., as described with respect to 402d). In some embodiments, the predefined data is sent via an Inter-Process Communication between a first processor running the system process and a second processor running the application of the device. In some embodiments, the predefined data is identifiable by the application of the device as non-valid sensor data. In some embodiments, the predefined data mimics a format of actual sensor data from the first sensor such as a vector data structure with non-zero and/or real-time values for when the sensor data from the first sensor is enabled to be received by the application of the device and the same vector data structure with 0 values when the sensor data is disabled to be received by the application of the device.

In some embodiments, while (and/or after) disabling, the application (e.g., 402a) of the device, to receive sensor data from the first sensor, the system process receives, from the first process (e.g., 406a), an indication of the first orientation (and/or that the respective orientation of the device changed from the second orientation (e.g., face down, facing a second direction different from the first direction, and/or an obstructed orientation) to the first orientation) of the portion of the device (e.g., as described with respect to after 402d). In some embodiments, in response to receiving the indication of the first orientation of the portion of the device, the system process enables, the application of the device, to receive sensor data from the first sensor (e.g., as described with respect to after 402d).

In some embodiments, while (and/or after) enabling, the application (e.g., 402a) of the device, to receive sensor data from the first sensor, the system process receives, from the first process (e.g., 406a), an indication of the second orientation of the portion of the device (and/or that a current orientation of the portion of the device changed from the first orientation (e.g., face up, facing the first direction, and/or an unobstructed orientation) to the second orientation). In some embodiments, in response to receiving the indication of the second orientation of the portion of the device, the system process continues to enable, the application of the device, to receive sensor data from the first sensor.

In some embodiments, the indication of the respective orientation of the portion of the device (e.g., sent in 406b) uses sensor data from a set of one or more sensors (e.g., accelerometer, infrared sensor, Inertial Measurement Unit, ambient light sensor, and/or gyroscope) (e.g., 308) not including the first sensor.

In some embodiments, the application (e.g., 402a) is a first application. In some embodiments, the system process receives, from a second application of the device (e.g., the first application of the device or another application different from the first application), a request for sensor data from a second sensor (e.g., ambient light sensor, accelerometer, Inertial Measurement Unit, Global Positioning System, and/or pedometer) different from the first sensor (e.g., as described with respect to after 402d). In some embodiments, in response to receiving the request for sensor data from the second sensor, in accordance with a determination that a current orientation of the portion of the device is the first orientation, the system process enables, the second application of the device, to receive sensor data from the second sensor (e.g., as described with respect to after 402d). In some embodiments, in response to receiving the request for sensor data from the second sensor, in accordance with a determination that the current orientation of the portion of the device is the second orientation, the system process enables, the second application of the device, to receive sensor data from the second sensor (e.g., the system process enables, the second application of the device, to receive sensor data from the second sensor irrespective of the respective orientation (e.g., face up, face down, vertical, horizontal, or angled) of the portion of the device) (e.g., as described with respect to after 402d).

In some embodiments, the application (e.g., 402a) of the device is a first application of the device. In some embodiments, the request for sensor data (e.g., sent in 402b) from the first sensor is a first request for sensor data from the first sensor. In some embodiments, the request for an orientation of the portion of the device (e.g., sent in 404b) is a first request for an orientation of the portion of the device. In some embodiments, the respective orientation is a first respective orientation. In some embodiments, the system process receives, from a third application of the device different from the first application of the device, a second request for sensor data from the first sensor (e.g., as described with respect to after 402d). In some embodiments, in response to receiving the second request for sensor data from the first sensor, the system process sends, to the first process (e.g., 406a), a second request for an orientation (e.g., current orientation, such as an angle and/or direction) of the portion (e.g., a portion that physically includes the first sensor, an output device, and/or an input device) of the device (e.g., as described with respect to after 402d). In some embodiments, after (e.g., as a result of and/or as a response to) sending the second request for an orientation of the portion of the device, the system process receives, from the first process, an indication of a second respective orientation of the portion of the device (e.g., as described with respect to after 402d). In some embodiments, in response to receiving the indication of the second respective orientation of the portion of the device, in accordance with a determination that the second respective orientation is the first orientation (e.g., face up, facing a first direction, and/or an unobstructed orientation), the system process enables, the third application of the device, to receive sensor data from the first sensor (e.g., as described with respect to after 402d). In some embodiments, enabling, the third application, to receive sensor data from the first sensor includes requesting and/or obtaining sensor data from the first sensor. In some embodiments, in response to receiving the indication of the second respective orientation of the portion of the device, in accordance with a determination that the second respective orientation is the second orientation (e.g., face down, facing a second direction different from the first direction, and/or an obstructed orientation), the system process disables, the third application of the device, to receive sensor data from the first sensor (e.g., as described with respect to after 402d). In some embodiments, the third application is another user application that follows a same security protocol and permission model as the first application of the device. In some embodiments, the third application runs on an application processor where user applications live and/or execute.

In some embodiments, the application (e.g., 402a) of the device is a first application of the device. In some embodiments, the request for sensor data (e.g., sent in 402b) from the first sensor is a first request for sensor data from the first sensor. In some embodiments, the system process receives, from a fourth application of the device (e.g., system application, system agent application, and/or accessibility application) different from the first application of the device, a third request for sensor data from the first sensor (e.g., as described with respect to after 402d). In some embodiments, in response to receiving the third request for sensor data from the first sensor and without sending a request for an orientation of the portion of the device (and/or not in accordance with a determination that a current orientation of the portion of the device is a particular orientation), the system process enables, the fourth application of the device, to receive sensor data from the first sensor (e.g., as described with respect to after 402d). In some embodiments, enabling, the fourth application, to receive sensor data from the first sensor includes requesting and/or obtaining sensor data from the first sensor. In some embodiments, the system process maintains a whitelist of trusted system-level applications that are granted unrestricted sensor access, and the fourth application is a trusted system-level application. In some embodiments, the fourth application is another user application that follows a same security protocol and permission model as the first application of the device. In some embodiments, the fourth application runs on an application processor where user facing applications live and/or execute.

Note that details of the processes described above with respect to process 500 (e.g., FIG. 5) are also applicable in an analogous manner to other processes described herein. For example, process 600 optionally includes one or more of the characteristics of the various processes described above with reference to process 500. For example, the device of process 600 can be the device of process 500. For brevity, these details are not repeated herein.

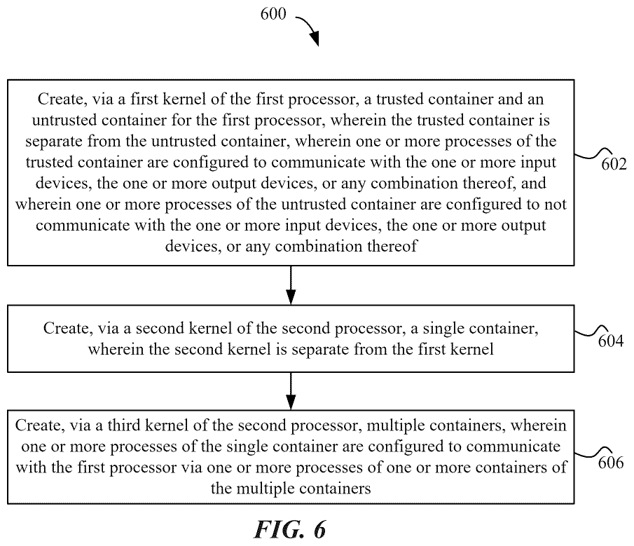

FIG. 6 is a flow diagram illustrating a process (e.g., process 600) for managing processes in a containerized multiprocessor system that is in communication with sensors in accordance with some embodiments. Some operations in process 600 are, optionally, combined, the orders of some operations are, optionally, changed, and some operations are, optionally, omitted.

As described below, process 600 provides an intuitive way for managing processes in a containerized multiprocessor system that is in communication with sensors. Process 600 reduces the cognitive burden on a user, thereby creating a more efficient human-machine interface. For battery-operated computing devices, enabling a user to interact with such devices faster and more efficiently conserves power and increases the time between battery charges.

In some embodiments, process 600 is performed at a device (e.g., 300), by a memory management process (e.g., 304b) (e.g., SPTM (Secure Page Table Monitor), virtual memory manager, operating system process, and/or application process), that is in communication with one or more input devices (e.g., a camera, infrared sensor, IMU (Inertial Measurement Unit), a depth sensor, a microphone, a hardware input mechanism, a rotatable input mechanism, a physical input mechanism, a button, a crown, a knob, a dial, a physical slider, an accelerometer, a mouse, a keyboard, a touchpad, and/or a touch-sensitive surface) (e.g., 308), one or more output devices (e.g., infrared flood, a display generation component, an audio generation component, and/or a haptic generation component), or any combination thereof and that includes a first processor (e.g., 302a) (e.g., always-on processor, co-processor, low-power microcontroller, CPU, and/or GPU) and a second processor (e.g., 304a) (e.g., application processor, co-processor, main CPU, and/or GPU). In some embodiments, the device is a computer system, a watch, a phone, a tablet, a fitness tracking device, a processor, a head-mounted display (HMD) device, a communal device, a media device, a speaker, a television, an electronic device, and/or a personal computing device. In some embodiments, the memory management process is a process of an operating system (e.g., 304c) of the device. In some embodiments, the memory management process is executing on the first processor, the second processor, or another processor different from the first processor and the second processor. In some embodiments, the memory management process restricts and/or enables access to memory and/or process containers on the first processor and/or the second processor. In some embodiments, the one or more input devices and/or the one or more output devices include an inertial measurement unit in a secure domain of the first processor.

The memory management process creates (602), via a first kernel (e.g., 306) of (e.g., executing on and/or loaded on) the first processor, a trusted container (e.g., 302c) (e.g., trusted execution environment, isolated memory region, and/or secure enclave) and an untrusted container (e.g., 302d) (e.g., non-secure execution environment and/or shared memory region) for the first processor, wherein the trusted container is separate from (e.g., different from and/or isolated from) the untrusted container, wherein one or more processes (e.g., any process) of the trusted container are configured to communicate with the one or more input devices, the one or more output devices, or any combination thereof, and wherein one or more processes (e.g., any process) of the untrusted container are configured to not communicate with the one or more input devices, the one or more output devices, or any combination thereof. In some embodiments, the first kernel is a CL4. In some embodiments, creating the trusted container includes configuring one or more processes (e.g., any process) of the trusted container to communicate with the one or more input devices and/or the one or more output devices. In some embodiments, after creating the trusted container, the memory management process configures one or more processes (e.g., any process) of the trusted container to communicate with the one or more input devices and/or the one or more output devices. In some embodiments, creating a container (e.g., the trusted container and/or the untrusted container) includes allocating memory, configuring memory protection, and/or configuring one or more security policies.

The memory management process creates (604), via a second kernel (e.g., 304h) of (e.g., executing on and/or loaded on) the second processor, a single container (e.g., 304i), wherein the second kernel is separate from the first kernel. In some embodiments, the second kernel is an operating system kernel. In some embodiments, the single container is an application environment and/or primary user and/or application space. In some embodiments, the second kernel creates and/or manages the single container where one or more applications run and/or execute. In some embodiments, the second kernel does not perform additional compartmentalization on the single container.

The memory management process creates (606), via a third kernel (e.g., 304c) of (e.g., executing on and/or loaded on) the second processor, multiple containers (e.g., 304c and/or 304f), wherein one or more processes (e.g., any process) of the single container (e.g., 304i) are configured to communicate with the first processor (e.g., the trusted container and/or the untrusted container) via one or more processes (e.g., 304d and/or another process) of one or more containers of the multiple containers. In some embodiments, the second kernel is an operating system kernel and the third kernel creates multiple Silo containers. In some embodiments, dedicated buses (e.g., 310) are used for the one or more input devices and/or the one or more output devices to communicate with one or more processes of the trusted container, and the untrusted container cannot directly access the dedicated buses.

In some embodiments, the one or more input devices includes a first sensor. In some embodiments, the memory management process receives an indication that first sensor data has been detected by a first sensor (e.g., as described above with respect to FIG. 1). In some embodiments, receiving the indication that first sensor data has been detected by the first sensor includes receiving sensor data from the first sensor. In some embodiments, receiving the indication that first sensor data has been detected by the first sensor does not include receiving sensor data from the first sensor. In some embodiments, in response to receiving the indication that the first sensor data has been detected by the first sensor, the memory management process initially provides (e.g., before providing to another container different from the trusted container), to the trusted container (e.g., 302c), the first sensor data. In some embodiments, initially providing the first sensor data from the first sensor to the trusted container includes mapping a virtual memory address to a physical memory address on the trusted container. In some embodiments, in response to receiving the indication that the first sensor data has been detected by the first sensor and in accordance with a determination that the trusted container does not have permission to receive sensor data from the first sensor, the memory management process forgoes provision of the first sensor data from the first sensor to the trusted container. In some embodiments, the memory management process sends a message to the trusted container of where the first sensor data is stored. In some embodiments, the memory management process manages access permissions to ensure that only authorized processes of the trusted container can store, access and/or modify the first sensor data from the first sensor. In some embodiments, initially providing the first sensor data from the first sensor to the trusted container includes writing the first sensor data to memory of the trusted container and/or checking requested memory access of the trusted container against security policies of the memory management process. In some embodiments, initially providing the first sensor data from the first sensor to the trusted container includes assigning the first sensor data to the trusted container (e.g., allocating a memory mapping on a page table corresponding to the trusted container, and/or creating a secure memory region within an address space of the trusted container). In some embodiments, directing the first sensor data from the first sensor to a specific memory location within the trusted container includes configuring direct memory access for data transfer between the first sensor and the trusted container. In some embodiments, the memory management process stores the first sensor data from the first sensor in a protected memory region that is only accessible to authorized processes within the trusted container and/or implements encryption of the first sensor data from the first sensor before storing the first sensor data in memory of the trusted container. In some embodiments, before initially providing the first sensor data from the first sensor to the trusted container, the memory management process checks a security policy to ensure that the trusted container has necessary permissions for receiving and/or storing sensor data from the first sensor, verifies integrity of the trusted container, and/or authenticates the request from the first kernel.

In some embodiments, after initially providing, to the trusted container (e.g., 302c), the first sensor data, the memory management process provides, to the single container (e.g., 304i), the first sensor data. In some embodiments, the first sensor data is provided to the single container using an Inter-Process Communication mechanism. In some embodiments, the trusted container processes and/or filters the first sensor data from the first sensor before the first sensor data is sent to the single container. In some embodiments, the first sensor data is provided to the single container via the third kernel. In some embodiments, the first sensor data is provided to the single container via a shared and/or secure memory region that is accessible by processes of the trusted container and/or processes of the single container. In some embodiments, the memory management process verifies that the single container is authorized to receive sensor data from the first sensor from the trusted container before providing the first sensor data to the single container. In some embodiments, the first sensor data is provided to the single container in a read-only format.

In some embodiments, after initially providing, to the trusted container (e.g., 302c), the first sensor data (and/or after providing, to the single container, the first sensor data), the memory management process provides, to the untrusted container (e.g., 302d), the first sensor data. In some embodiments, the first sensor data is provided to the untrusted container using an Inter-Process Communication mechanism. In some embodiments, before providing the first sensor data to the untrusted container, the trusted container processes, filters, and/or anonymizes the first sensor data. In some embodiments, the memory management process verifies that the untrusted container has permissions and/or is authorized to receive sensor data from the first sensor before facilitating a transfer. In some embodiments, the memory management process provides the first sensor data to the untrusted container via a shared memory region that is read-only for processes in the untrusted container. In some embodiments, the first kernel facilitates provision of the first sensor data to the untrusted container.

In some embodiments, after initially providing, to the trusted container (e.g., 302c), the first sensor data (and/or after providing, to the untrusted container and/or to the single container, the first sensor data) and in accordance with a determination that a set of one or more criteria is satisfied (e.g., that permission has been given to the container to receive sensor data corresponding to the first sensor), the memory management process provides, to a container of the multiple containers (e.g., 304c and/or 304f), the first sensor data. In some embodiments, the first sensor data is provided to the container of the multiple containers using an Inter-Process Communication mechanism. In some embodiments, the memory management process verifies integrity and/or an authorization of the container of the multiple containers before the first sensor data is provided to the container of the multiple containers. In some embodiments, the first sensor data is encrypted by the trusted container before being provided to the container of the multiple containers. In some embodiments, the third kernel facilitates provision of the first sensor data from the first sensor to the container of the multiple containers. In some embodiments, after initially providing, to the trusted container, the first sensor data (and/or after providing, to the untrusted container and/or to the single container, the first sensor data) and in accordance with a determination that the set of one or more criteria is not satisfied (e.g., that permission has not been given to the container to receive sensor data corresponding to the first sensor), the memory management process forgoes provision of, to the container of the multiple containers, the first sensor data. In some embodiments, the set of one or more criteria includes a criterion that is satisfied when permission has been given to the container to receive sensor data corresponding to the first sensor.

In some embodiments, the set of one or more criteria is satisfied when a system process (e.g., that detects an orientation of the device and/or whether a light is active to indicate that sensor data is being provided to a process) (e.g., 404a) associated with (e.g., of, executing using, and/or executing on the same processor as) the third kernel (e.g., 304c) has provided permission to the container to receive sensor data corresponding to the first sensor (e.g., as described with respect to 402c). In some embodiments, the set of one or more criteria is not satisfied when the system process associated with the third kernel has not provided permission to the container to receive sensor data corresponding to the first sensor (e.g., as described with respect to 402d). In some embodiments, the set of one or more criteria includes a criterion that is satisfied when the device is face-up, is facing a first direction, and/or is in an unobstructed orientation. In some embodiments, the set of one or more criteria includes a criterion that is not satisfied when the device is face-down, is facing a second direction different from the first direction, and/or is in an obstructed orientation. In some embodiments, the system process manages a relationship between sensor states and/or device indicators to ensure that a sensor indication of the first sensor matches a sensor state of the first sensor, such as communicating with one or more processes hardware indicators. In some embodiments, the third kernel facilitates provision of the first sensor data from the first sensor to the single container based on second sensor data (e.g., sensor state and/or sensor indication) of the system process.

In some embodiments, the memory management process receives an indication that second sensor data has been detected by a second sensor. In some embodiments, in response to receiving the indication that the second sensor data has been detected by the second sensor, the memory management process initially provides (e.g., before providing to another container different from the untrusted container), to the untrusted container (e.g., 302d), the second sensor data. In some embodiments, the memory management process maps a virtual memory address to a physical memory address on the untrusted container for storing the second sensor data of the second sensor. In some embodiments, the memory management process manages access permissions to ensure that only authorized processes of the untrusted container can receive (e.g., store, and/or access) the second sensor data of the second sensor. In some embodiments, the first kernel facilitates provision of the sensor data of the second sensor to the untrusted container that includes passing through the memory management process that checks requested memory access of the untrusted container and/or of the second sensor data of the second sensor against a set of security policies. In some embodiments, the memory management process stores the second sensor data of the second sensor in a memory region that is accessible to authorized processes within the untrusted container. In some embodiments, the second sensor data is initially provided to the untrusted container using an Inter-Process Communication mechanism.

In some embodiments, the memory management process receives an indication that third sensor data has been detected by a third sensor. In some embodiments, in response to receiving the indication that the third sensor data has been detected by the third sensor, the memory management process initially provides (e.g., before providing to another container different from the single container), to the single container (e.g., 304i), the third sensor data. In some embodiments, the third sensor data is provided to the single container via the third kernel and/or the first kernel. In some embodiments, the memory management process verifies that the single container is authorized to receive the third sensor data of the third sensor from the trusted container before facilitating provision of the third sensor data of the third sensor to the single container. In some embodiments, the third sensor data of the third sensor is provided to the single container in a read-only format. In some embodiments, the third sensor data is provided to the single container includes using an Inter-Process Communication mechanism. In some embodiments, the third sensor data is provided to the single container via a shared and/or secure memory region that is accessible by processes of the trusted container and/or processes of the single container. In some embodiments, the trusted container processes and/or filters the sensor data of the third sensor before sending the sensor data of the third sensor to the single container.

In some embodiments, the memory management process receives an indication that fourth sensor data has been detected by a fourth sensor. In some embodiments, in response to receiving the indication that the fourth sensor data has been detected by the fourth sensor, the memory management process initially provides to a container of the multiple containers (e.g., 304c and/or 304f), the fourth sensor data (e.g., before providing to another container different from the container of the multiple containers). In some embodiments, the fourth sensor data is provided to the container of the multiple containers via an Inter-Process Communication mechanism. In some embodiments, the memory management process verifies integrity and/or an authorization of the container of the multiple containers before allowing provision of the fourth sensor data of the fourth sensor to the container of the multiple containers. In some embodiments, the fourth sensor data of the fourth sensor is encrypted before providing the fourth sensor data of the fourth sensor to the container of the multiple containers. In some embodiments, the first kernel and/or the third kernel facilitates provision of the fourth sensor data of the fourth sensor to the container of the multiple containers.

In some embodiments, communication between a first container (e.g., the trusted container, the untrusted container, a first container of the multiple containers, and/or the single container) (e.g., 304i, 304c, 304f, 302c, and/or 302d) and a second container (e.g., the trusted container, the untrusted container, a second container of the multiple containers different from the first container of the multiple containers, and/or the single container) (e.g., 304i, 304c, 304f, 302c, and/or 302d) is via Inter-Process Communication. In some embodiments, the second container is different from the first container. In some embodiments, the Inter-Process Communication is facilitated by the memory management process that manages shared memory regions accessible for authorized processes of the first container and second container. In some embodiments, the Inter-Process Communication is logged by the memory management process. In some embodiments, the memory management process verifies permissions of processes of the first container and the second container before allowing the Inter-Process Communication to occur.

Note that details of the processes described above with respect to process 600 (e.g., FIG. 6) are also applicable in an analogous manner to other processes described herein. For example, process 500 optionally includes one or more of the characteristics of the various processes described above with reference to process 600. For example, the application of process 500 can be a process of the one or more processes of the untrusted container of process 600. For brevity, these details are not repeated herein.

FIG. 7 is a flow diagram illustrating a process (e.g., process 700) for performing an operation requiring sensor access based on an orientation of a device and previous sensor data in accordance with some embodiments. Some operations in process 700 are, optionally, combined, the orders of some operations are, optionally, changed, and some operations are, optionally, omitted.

As described below, process 700 provides an intuitive way for performing an operation requiring sensor access based on an orientation of a device and previous sensor data. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a device (e.g., 300) that is communication with one or more sensors (e.g., IMU motion sensor, and/or infrared proximity sensor) (e.g., at a system process and/or an application of the device) (e.g., 308) and one or more input devices (e.g., a camera, a depth sensor, a microphone, a hardware input mechanism, a rotatable input mechanism, a physical input mechanism, a button, a crown, a knob, a dial, a physical slider, an accelerometer, a mouse, a keyboard, a touchpad, and/or a touch-sensitive surface) (e.g., 308). In some embodiments, the device is a computer system, a watch, a phone, a tablet, a fitness tracking device, a processor, a head-mounted display (HMD) device, a communal device, a media device, a speaker, a television, an electronic device, and/or a personal computing device. In some embodiments, process 700 is performed by a system process. In some embodiments, the system process is a process of an operating system (e.g., 304c) of the device. In some embodiments, the one or more input devices includes a camera, a depth sensor, a microphone, a hardware input mechanism, a rotatable input mechanism, a heart monitor, a temperature sensor, and/or a touch-sensitive surface.

The device receives (702) (e.g., via the one or more input devices and/or from an application (e.g., 402a) of the device or another device different from the device) a request to perform an operation (e.g., use sensor data from a third sensor, such as a microphone or camera) (e.g., as described with respect to 402b). In some embodiments, the application is a user application of the device, such as an application that was installed on the device.

In response to (704) receiving the request to perform the operation, in accordance with a determination that a first set of one or more criteria are satisfied (e.g., as described with respect to 404c and 404d), wherein the first set of one or more criteria includes a first criterion that is satisfied when the device is in a first orientation (e.g., face down, facing a first direction, and/or an obstructed orientation) (e.g., as described with respect to 404c), wherein the first set of one or more criteria include a second criterion that is satisfied when sensor data of the one or more sensors that is detected before receiving the request to perform the operation satisfies a second set of one or more criteria (e.g., the device is not stable, the device underwent an acceleration and/or sudden change in velocity, and/or the device is in irregular motion) different from the first set of one or more criteria (e.g., as described with respect to 404d), the device performs (706) the operation (e.g., as described with respect to 402c). In some embodiments, determining that the device is in the first orientation includes determining that the device is in proximity to a surface and/or not in motion.

In response to (704) receiving the request to perform the operation, in accordance with a determination that a third set of one or more criteria, different from the first set of one or more criteria and the second set of one or more criteria, are satisfied (e.g., as described with respect to 404c and 404d), wherein the third set of one or more criteria include the first criterion that is satisfied when the device is in the first orientation (e.g., 404c), wherein the third set of one or more criteria include a third criterion that is satisfied when the sensor data of the one or more sensors that is detected before receiving the request to perform the operation satisfies a fourth set of one or more criteria (e.g., the device is stable, the device is not in motion, and/or the device is in steady motion) different from the first set of one or more criteria, the second set of one or more criteria, and the third set of one or more criteria (e.g., 404d), the device forgoes (708) performance of the operation (e.g., as described with respect to 402d).

In response to (704) receiving the request to perform the operation, in accordance with a determination that a fifth set of one or more criteria (e.g., the device is face up and/or the device is in proximity to a surface and/or the device is in motion or the device is face up and/or the device is not in proximity to a surface and/or the device is in motion), different from the first set of one or more criteria, the second set of one or more criteria, the third set of one or more criteria, and the fourth set of one or more criteria, are satisfied (e.g., as described with respect to 404c), wherein the fifth set of one or more criteria include a criterion that is satisfied when the device is in a second orientation (e.g., face up, facing a second direction different from the first direction, and/or an unobstructed orientation) (e.g., irrespective of sensor data detected before receiving the request to perform the operation) different from the first orientation, the device performs (710) the operation (e.g., as described with respect to 402c).

In some embodiments, the operation is performed using sensor data from a first sensor (e.g., camera or microphone) not included in the one or more sensors (e.g., 308). In some embodiments, performing the operation includes initiating a phone call or video call.

In some embodiments, the one or more sensors (e.g., 308) include an Inertial Measurement Unit, an infrared proximity sensor, or any combination thereof. In some embodiments, the device uses sensor data from the Inertial Measurement Unit to determine a respective orientation of the device (e.g., the first orientation or the second orientation). In some embodiments, the device uses sensor data from the infrared proximity sensor to determine the respective orientation of the device (e.g., the first orientation or the second orientation). In some embodiments, the device uses a combination of sensor data from the Inertial Measurement Unit and the infrared proximity sensor to determine the respective orientation of the device.

In some embodiments, the first criterion is satisfied based on sensor data detected by the one or more sensors (e.g., 308) (e.g., the first orientation is detected based on sensor data detected by the one or more sensors). In some embodiments, the criterion of the fifth set of one or more criteria is satisfied based on sensor data detected by the one or more sensors (e.g., the second orientation is detected based on sensor data detected by the one or more sensors).

In some embodiments, the first criterion is satisfied based on sensor data detected by a sensor not included in the one or more sensors (e.g., 308) (e.g., the first orientation is detected based on sensor data detected by a sensor not included in the one or more sensors). In some embodiments, the criterion of the fifth set of one or more criteria is satisfied based on sensor data detected by a sensor not included in the one or more sensors (e.g., the second orientation is detected based on sensor data detected by a sensor not included in the one or more sensors).

In some embodiments, the second set of one or more criteria include a criterion that is satisfied when a first amount (e.g., high amount, dangerous amount, and/or threshold-exceeding value) of motion (e.g., velocity, acceleration, and/or stability) is detected before receiving the request to perform the operation. In some embodiments, the third set of one or more criteria include a criterion that is satisfied when a second amount (e.g., low amount, and/or below-threshold value) of motion, different from the first amount of motion, is detected before receiving the request to perform the operation.

In some embodiments, the second set of one or more criteria include a criterion that is satisfied when a first input (e.g., audio input and/or audio input over a threshold loudness and/or pattern) is detected before receiving the request to perform the operation. In some embodiments, the third set of one or more criteria include a criterion that is satisfied when the first input is not detected (e.g., the first input is not detected or detected below the threshold loudness and/or pattern) before receiving the request to perform the operation. In some embodiments, the first input is detected via a microphone. In some embodiments, the first input is an indicator of a state of the device (e.g., undergoing a car crash or not undergoing a car crash).

Note that details of the processes described above with respect to process 700 (e.g., FIG. 7) are also applicable in an analogous manner to the processes described herein. For example, process 600 optionally includes one or more of the characteristics of the various processes described herein with reference to process 700. For example, the device of process 600 can be the device of process 700. For brevity, these details are not repeated herein.

In some embodiments, one or more of processes 500, 600, and 700 (FIGS. 5, 6, and 7) is performed at a first computer system (as described herein) via a system process (e.g., an operating system process and/or a server system process) that is different from one or more applications executing and/or installed on the first computer system.

In some embodiments, one or more of processes 500, 600, and 700 (FIGS. 5, 6, and 7) is performed at a first computer system (as described herein) by an application that is different from a system process.

In some embodiments, the instructions of the application, when executed, control the first computer system to perform one or more of processes 500, 600, and 700 (FIGS. 5, 6, and 7) by calling an application programming interface (API) provided by the system process. In some embodiments, the application performs at least a portion of one or more of processes 500, 600, and 700 (FIGS. 5, 6, and 7) without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform one or more of processes 500, 600, and 700 (FIGS. 5, 6, and 7) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, processes, procedures, data structures, classes, and/or other services provided by a set of implementation instructions of the system process. The API can define one or more parameters that are passed between the API calling instructions and the implementation instructions.

As described above, in some embodiments, an application controls a computer system to perform processes 500, 600, and 700 (FIGS. 5, 6, and 7) by calling an application programming interface (API) provided by a system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, API 176 defines a first API call that can be provided by API calling instructions 174, wherein the definition for the first API call specifies call parameters described above with respect to processes 500, 600, and 700 (FIGS. 5, 6, and 7).

In some embodiments, API 176 defines a first API call response that can be provided to an application by API calling instructions 174, wherein the first API call response includes parameters described above with respect to processes 500, 600, and 700 (FIGS. 5, 6, and 7).

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call.

In some embodiments, the set of implementation instructions is included in the device (e.g., 168) that runs the application. In some embodiments, the set of implementation instructions is included in an electronic device that is separate from the device that runs the application.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve how a device manages access to sensor data based on device orientation and/or other timely sensor data. The present disclosure contemplates that in some instances, this gathered data can include sensor data from one or more input and/or output (IO) devices, including but not limited to an Inertial Measurement Unit, Infrared proximity sensor, camera, microphone, gyroscope, and/or touch-sensitive surface. The sensor data may include device orientation data and/or motion data that could potentially be used to infer user activity and/or behavior.

The present disclosure recognizes that the use of such sensor data, in the present technology, can be used to the benefit of users. For example, the sensor data can be used to change how a device interacts with a user. Accordingly, use of such sensor data enables better user interactions. Further, other uses for sensor data that benefit the user are also contemplated by the present disclosure.

The present disclosure further contemplates that the entities responsible for the collection, analysis, disclosure, transfer, storage, or other use of such sensor data will comply with well-established privacy policies and/or privacy practices. In particular, such entities should implement and consistently use privacy policies and practices that are generally recognized as meeting or exceeding industry or governmental requirements for maintaining sensor data private and secure. For example, sensor from user devices should be collected for legitimate and reasonable uses of the entity and not shared or sold outside of those legitimate uses. Further, such collection should occur only after receiving the informed consent of the users. Additionally, such entities would take any needed steps for safeguarding and securing access to such sensor data and ensuring that others with access to the sensor data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, sensor data. That is, the present disclosure contemplates that hardware and/or software elements can be provided to prevent or block access to such sensor data. For example, in the case of image capture, the present technology can be configured to allow users to select to “opt in” or “opt out” of participation in the collection of sensor data during registration for services.

Therefore, although the present disclosure broadly covers use of sensor data to implement one or more various disclosed embodiments, the present disclosure also contemplates that the various embodiments can also be implemented without the need for accessing such sensor data. That is, the various embodiments of the present technology are not rendered inoperable due to the lack of all or a portion of such sensor data. For example, device orientation can be inferred via alternative means to sensor data such as user input patterns, time-based rules, GPS-derived movement patterns, power consumption levels, and/or network connectivity patterns.

What is claimed is:

1. A method, comprising:
at a device, by a system process of the device, that is in communication with a first sensor:
receiving, from an application of the device, a request for sensor data from the first sensor;
in response to receiving the request for sensor data from the first sensor, sending, to a first process different from the system process, a request for an orientation of a portion of the device;
after sending the request for an orientation of the portion of the device, receiving, from the first process, an indication of a respective orientation of the portion of the device; and
in response to receiving the indication of the respective orientation of the portion of the device:
in accordance with a determination that the respective orientation is a first orientation, enabling, the application of the device, to receive sensor data from the first sensor; and
in accordance with a determination that the respective orientation is a second orientation different from the first orientation, disabling, the application of the device, to receive sensor data from the first sensor.

2. The method of claim 1, wherein the first sensor includes a camera.

3. The method of claim 1, wherein the first sensor includes a microphone.

4. The method of claim 1, wherein the application is a user application.

5. The method of claim 1, wherein the system process is executing on a first processor, and wherein the first process is executing on a second processor different from the first processor.

6. The method of claim 1, further comprising:
in response to receiving the indication of the respective orientation of the portion of the device:
in accordance with the determination that the respective orientation is the first orientation, causing a light, of the device, to be turned on; and
in accordance with the determination that the respective orientation is the second orientation, forgoing causing the light, of the device, to be turned on.

7. The method of claim 6, further comprising:
before receiving the request for sensor data from the first sensor and in accordance with a determination that sensor data from the first sensor is not being provided to an application, causing the light, of the device, to be turned off.

8. The method of claim 1, wherein enabling, the application of the device, to receive sensor data from the first sensor includes sending, to the application of the device, sensor data from the first sensor.

9. The method of claim 1, wherein disabling, the application of the device, to receive sensor data from the first sensor includes sending, to the application of the device, an error message.

10. The method of claim 1, wherein disabling, the application of the device, to receive sensor data from the first sensor includes sending, to the application of the device, predefined data.

11. The method of claim 1, further comprising:
while disabling, the application of the device, to receive sensor data from the first sensor, receiving, from the first process, an indication of the first orientation of the portion of the device; and
in response to receiving the indication of the first orientation of the portion of the device, enabling, the application of the device, to receive sensor data from the first sensor.

12. The method of claim 1, further comprising:
while enabling, the application of the device, to receive sensor data from the first sensor, receiving, from the first process, an indication of the second orientation of the portion of the device; and
in response to receiving the indication of the second orientation of the portion of the device, continuing to enable, the application of the device, to receive sensor data from the first sensor.

13. The method of claim 1, wherein the indication of the respective orientation of the portion of the device uses sensor data from a set of one or more sensors not including the first sensor.

14. The method of claim 1, wherein the application is a first application, the method further comprising:
receiving, from a second application of the device, a request for sensor data from a second sensor different from the first sensor; and
in response to receiving the request for sensor data from the second sensor:
in accordance with a determination that a current orientation of the portion of the device is the first orientation, enabling, the second application of the device, to receive sensor data from the second sensor; and
in accordance with a determination that the current orientation of the portion of the device is the second orientation, enabling, the second application of the device, to receive sensor data from the second sensor.

15. The method of claim 1, wherein the application of the device is a first application of the device, wherein the request for sensor data from the first sensor is a first request for sensor data from the first sensor, wherein the request for an orientation of the portion of the device is a first request for an orientation of the portion of the device, wherein the respective orientation is a first respective orientation, the method further comprising:
receiving, from a third application of the device different from the first application of the device, a second request for sensor data from the first sensor;
in response to receiving the second request for sensor data from the first sensor, sending, to the first process, a second request for an orientation of the portion of the device;
after sending the second request for an orientation of the portion of the device, receiving, from the first process, an indication of a second respective orientation of the portion of the device; and
in response to receiving the indication of the second respective orientation of the portion of the device:
in accordance with a determination that the second respective orientation is the first orientation, enabling, the third application of the device, to receive sensor data from the first sensor; and
in accordance with a determination that the second respective orientation is the second orientation, disabling, the third application of the device, to receive sensor data from the first sensor.

16. The method of claim 1, wherein the application of the device is a first application of the device, wherein the request for sensor data from the first sensor is a first request for sensor data from the first sensor, the method further comprising:
receiving, from a fourth application of the device different from the first application of the device, a third request for sensor data from the first sensor; and
in response to receiving the third request for sensor data from the first sensor and without sending a request for an orientation of the portion of the device, enabling, the fourth application of the device, to receive sensor data from the first sensor.

17. A non-transitory computer-readable storage medium storing one or more programs configured to be executed by one or more processors of a device, by a system process of the device, that is in communication with a first sensor, the one or more programs including instructions for:
receiving, from an application of the device, a request for sensor data from the first sensor;
in response to receiving the request for sensor data from the first sensor, sending, to a first process different from the system process, a request for an orientation of a portion of the device;
after sending the request for an orientation of the portion of the device, receiving, from the first process, an indication of a respective orientation of the portion of the device; and
in response to receiving the indication of the respective orientation of the portion of the device:
in accordance with a determination that the respective orientation is a first orientation, enabling, the application of the device, to receive sensor data from the first sensor; and
in accordance with a determination that the respective orientation is a second orientation different from the first orientation, disabling, the application of the device, to receive sensor data from the first sensor.

18. A device, by a system process of the device, configured to communicate with a first sensor, the device comprising:
one or more processors; and
memory storing one or more programs configured to be executed by the one or more processors, the one or more programs including instructions for:
receiving, from an application of the device, a request for sensor data from the first sensor;
in response to receiving the request for sensor data from the first sensor, sending, to a first process different from the system process, a request for an orientation of a portion of the device;
after sending the request for an orientation of the portion of the device, receiving, from the first process, an indication of a respective orientation of the portion of the device; and
in response to receiving the indication of the respective orientation of the portion of the device:
in accordance with a determination that the respective orientation is a first orientation, enabling, the application of the device, to receive sensor data from the first sensor; and
in accordance with a determination that the respective orientation is a second orientation different from the first orientation, disabling, the application of the device, to receive sensor data from the first sensor.
